(19) United States
(12) Patent Application Publication
(10) Pub. No.: US 2015/0058235 A1
(43) Pub. Date: Feb. 26, 2015

(54) SYSTEMS AND METHODS FOR FACILITATING AND COORDINATING ONLINE AND OFFLINE RELATIONSHIPS

(71) Applicant: KB Cubed, LLC, Los Angeles, CA (US)

(72) Inventors: Dennis Allen Kahan, Los Angeles, CA (US); Ilana Jacqueline Dreicer, Encino, CA (US); David Gregoire, Las Vegas, NV (US); Jessica S. Kimiabakhsh, Beverly Hills, CA (US); Christian Kroger, Las Vegas, NV (US); Robert Joshua Ravanshenas, Los Angeles, CA (US)

(73) Assignee: KB Cubed, LLC, Los Angeles, CA (US)

(21) Appl. No.: 13/973,612

(22) Filed: Aug. 22, 2013

(51) Int. Cl. G06Q 50/00; G06Q 10/10

(52) U.S. Cl. CPC G06Q 50/01; G06Q 10/1093
USPC 705/319

(57) ABSTRACT

A posting module enables a user to specify information for a first date posting, including a first date venue. Optionally, a database is accessed and information related to the first date venue is received. The first date posting is optionally populated with information specified by the first user and at least a portion of the information received via the database. A search engine may identify the first date posting at least partly in response to an action of a second user, and provide the first date posting for display to the second user. A module is configured to cause an invitation control to be displayed to the second user in association with the first date posting, detect the second user activating the invitation control, and cause an invitation, to go on a date corresponding to the first date posting of the first user, to be presented to the first user.

### BACKGROUND OF THE INVENTION

1. Field of the Invention

The present invention is related to searching, data matching, and facilitating relationships.

2. Description of the Related Art

Certain conventional dating systems focus on identifying users that may be romantically compatible based on their values, character traits, and locations. Such conventional dating systems tend to require an undue amount of user interaction and tend to result in unsatisfactory numbers of dates.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect provides a posting module that enables a user to specify information for a first date posting, including a first date venue. Optionally, a database is accessed and information related to the first date venue is received. The first date posting is optionally populated with information specified by the first user and at least a portion of the information received via the database. A search engine may identify the first date posting at least partly in response to an action of a second user, and provide the first date posting for display to the second user. A module causes an invitation control to be displayed to the second user in association with the first date posting, detects the second user activating the invitation control, and causes an invitation, to go on a date corresponding to the first date posting of the first user, to be presented to the first user.

An example aspect provides a system configured to facilitate relationships, the system comprising: at least one processing device; a posting module stored in non-transitory memory and executable by the at least one processing device, the posting module configured to enable a user to specify via a first interface information for a date posting, including at least a date venue, calendar day, and time to be included in the date posting; a first application programming interface configured to: access at least a portion of the information specified by a first user for a first date posting, including at least a first date venue specified by the first user, access a database associated with the first date venue specified by the first user, or access a database associated with a third party service provider storing information related to the first date venue, or access the database associated with the first date venue specified by the first user and the database associated with a third party service provider storing information related to the first date venue; receive information related to the first date venue from the database associated with the first date venue, or the database associated with a third party service provider, or the database associated with the first date venue specified by the first user and the database associated with a third party service provider storing information related to the first date venue; a date posting population module, stored in non-transitory memory and executable by the at least one processing device, configured to populate the first date posting with at least a portion of the information specified by the first user and at least a portion of the information received via: the application programming interface from the database associated with the first date venue, or the database associated with a third party service provider, or the application programming interface from the database associated with the first date venue and the database associated with a third party service provider; a search engine configured to identify the first date posting at least partly in response to an action of a second user, and to provide the first date posting, including at least a portion of the information received via the application programming interface, for display to the second user; a module, stored in non-transitory memory and executable by the at least one processing device, configured to: cause an invitation control to be displayed to the second user in association with the first date posting; detect whether the second user activated the invitation control; at least partly in response to detecting that the second user activated the invitation control, cause an invitation, to go on a date corresponding to the first date posting of the first user, to be presented to the first user; detect whether the first user accepted the invitation; at least partly in response to detecting that the first user accepted the invitation: notifying the second user regarding the acceptance, and charging the first user or the second user, or both the first user and the second user.

An example aspect provides a method, comprising: receiving at a computer system from a terminal associated with a first user a date posting, including at least a date venue, a calendar day, and a time to be included in the date posting; accessing, by the computer system, at least a portion of the information specified by a first user for a first date posting, including at least a first date venue specified by the first user, accessing: a database associated with the first date venue specified by the first user, or a database associated with a third party service provider storing information related to the first date venue, or the database associated with the first date venue specified by the first user and the database associated with a third party service provider storing information related to the first date venue; receiving information related to the first date venue from the database associated with the first date venue, or the database associated with a third party service provider, or the database associated with the first date venue specified by the first user and the database associated with a third party service provider storing information related to the first date venue; populating, by the computer system, the first date posting with at least a portion of the information specified by the first user and at least a portion of the information received from: the database associated with the first date venue, or the database associated with a third party service provider, or the database associated with the first date venue and the database associated with a third party service provider; identifying, using a first search engine executing on at least one computer system, the first date posting at least partly in response to an action of a second user; providing the first date posting, including at least a portion of the information received via the database associated with the first date venue, or the database associated with a third party service provider, or the database associated with the first date venue and the database associated with a third party service provider, for display to the second user; causing an invitation control to be displayed to the second user in association with the first date posting; detecting whether the second user activated the invitation control; at least partly in response to detecting that the second user activated the invitation control, causing an invitation, to go on a date corresponding to the first date posting of the first user, to be presented to the first user; detecting whether the first user accepted the invitation; at least partly in response to detecting that the first user accepted the invitation: notifying the second user regarding the acceptance, and charging the first user or the second user, or both the first user and the second user.

An example aspect provides a system comprising: at least one processing device; a first module stored in non-transitory memory and executable by the at least one processing device, the first module configured to enable a user to specify via a first interface information for a date posting, including at least a date venue. Optionally, a first application programming interface is provided that is configured to: access at least a portion of the information specified by a first user for a first date posting, including at least a first date venue specified by the first user. Optionally, the first module is configured to access a database associated with the first date venue specified by the first user, or access a database associated with a third party service provider storing information related to the first date venue, or access the database associated with the first date venue specified by the first user and the database associated with a third party service provider storing information related to the first date venue, or receive information related to the first date venue from the database associated with the first date venue, or the database associated with a third party service provider, or the database associated with the first date venue specified by the first user and the database associated with a third party service provider storing information related to the first date venue. Optionally, second module is provided configured to populate the first date posting with at least a portion of the information specified by the first user and at least a portion of the information received via: the application programming interface from the database associated with the first date venue, or the database associated with a third party service provider, or the application programming interface from the database associated with the first date venue and the database associated with a third party service provider. Optionally, a search engine is provided or utilized that is configured to identify the first date posting at least partly in response to an action of a second user, and to provide the first date posting, including at least a portion of the information received via the application programming interface, for display to the second user. Optionally, a third module is provided, stored in non-transitory memory and executable by the at least one processing device, and configured to: cause an invitation control to be displayed to the second user in association with the first date posting; detect whether the second user activated the invitation control; at least partly in response to detecting that the second user activated the invitation control, cause an invitation, to go on a date corresponding to the first date posting of the first user, to be presented to the first user; detect whether the first user accepted the invitation; at least partly in response to detecting that the first user accepted the invitation: notifying the second user regarding the acceptance, and optionally charging the first user or the second user, or both the first user and the second user.

### BRIEF DESCRIPTION OF THE DRAWINGS

Embodiments will now be described with reference to the drawings summarized below. These drawings and the associated description are provided to illustrate example embodiments, and not to limit the scope of the invention.

FIG. 1 illustrates an example architecture and operating environment.

FIG. 2 illustrates a first example process.

FIG. 3 illustrates a second example process.

FIGS. 4A-14 illustrate various example user interfaces.

### DETAILED DESCRIPTION OF EMBODIMENTS

Many conventional dating systems suffer from significant drawbacks. For example, many conventional dating systems are subscriber based, and operate primarily on the principle of identifying compatible matches based on subscriber demographics and other characteristics.

By way of illustration, conventional systems typically require that users pay a periodic subscription fee in order to utilize dating services of the dating system. Once a user agrees to be a subscriber, the subscriber then needs to enter subscriber characteristics as well as the characteristics desired in a potential match. For example, a subscriber may indicate subscriber characteristics such as some or all of the following: gender, age, birthdate, sexual preference(s), religion, political leanings, hobbies, etc. Often based solely on subscriber characteristics and the desired characteristics of potential matches, the system identifies potential matches to the subscriber. Such matching is often performed using complex, difficult to maintain algorithms, and requires a large computer-based architecture in order to simultaneously process large numbers of match requests.

Using certain of such conventional dating systems, once potential matches are identifies to subscribers, the matching subscribers need to communicate with each other to determine if they wish to actually meet for a date, and if so, to arrange a meeting place and time. Often left unsaid is who will pay for the date (e.g., whether one of the subscribers will pay for both, or whether each subscriber will pay for their portion of the date expenses, etc.), which may result in awkwardness and disappointment when the date actually takes place.

Thus, many conventional approaches are resource intensive, require significant manual interaction between subscribers in order to arrange a date, and require that subscribers pay periodic (e.g., monthly or yearly) fees. Often, using conventional systems, it can take weeks for a subscriber to arrange a single date.

Certain embodiments described herein may address one or more of the foregoing deficits of conventional dating systems.

Certain embodiments described herein facilitate the efficient, quick arrangement of dates, without requiring complex matching algorithms (although such may be used in conjunction with one or more features described herein). Certain embodiments enable a user to post a date, and another user viewing the posting may invite the posting user on the date.

As discussed in greater detail herein, certain embodiments optionally provide a fast match feature that provides a quick centralized mechanism enabling a user to quickly check the status with respect to dates that have been posted by the user. Certain embodiments optionally provide a daily dates user interface that enables a user to quickly identify posted dates that are available on short notice (e.g., for the current day). Certain embodiments optionally provide a “favorite dates” user interface that enables users to specify certain date venues or activity as favorites (without having to specify a particular day or time for a date), wherein matching posted dates are identified and a cumulative listing of matching posted dates is provided for display to the user. Certain embodiments optionally enable a user to define a watch list specifying people, venues and/or activities the user is interested in, but may not have decided to issue an invitation to or for, wherein dates posted by people on the watch list or for venues/activities on the watch list, are presented to the user. The various date and user information identified for presentation to the user may optionally be updated in substantially real-time and/or in response to the user accessing a corresponding user interface (e.g., a fast match, daily dates, favorite dates, and/or watch list user interface).

Certain embodiments are optionally date-centric rather than personality compatibility centric. For example, in certain embodiments, a dating event posting and matching system is provided. A user can specify and post a date event that a user is willing to participate in, and the system may store the date posting/specification for later use as described herein. For example, a user may post a date event category/type, a date event location, and/or a date event time. Optionally, the user may specify the number of date participants (e.g., 2 participants, or more than 2 participants for a group date). By way of illustration, a date event category may be one or more of the following (although it is understood that the following list is by way of example, and is not intended to be comprehensive):

having coffee together;

having a meal together (e.g., breakfast, brunch, lunch, dinner);

having drinks together;

going for a walk together;

attending to a movie together;

attending a concert together;

attending a sporting event together;

participating in a sporting event together (e.g., going golfing together, playing tennis together, going bowling tougher, etc.);

attending a lecture together;

going to a museum together;

going dancing together;

attending a religious service together;

meeting at a recreational facility (e.g., a park, beach, promenade, amusement park etc.).

The specified date event location may be a specific location/facility for the date. For example, if the date event category is “coffee” the user may specify a specific coffee house at a specific address, or may provide a list of specific coffee houses at respective specific addresses, that the user is willing to meet at for a date. By way of further example, the user may simply specify a region or city in which the user is willing to meet for date. Optionally, the user is required to specify a specific location (e.g., a specific coffee house at a specific address or location) to avoid requiring a great deal of interaction to arrange the date venue between prospective participants to a date.

A user may specify one or more specific calendar days and/or time or a range of calendar days and/or a time range. For example, the user may specify that the user is willing to meet on April 22 for a date. By way of further example, the user may specify that the user is willing to meet on April 22, April 26, or April 28 for a date. By way of yet further example, the user may specify that the user is willing to meet between April 22 and April 28. Similarly, the user may specify date time(s) and date length(s) (or ranges thereof) for the respective date days. Optionally, the user need not specify a time at all.

By way of further example, the user may specify a specific event, at a specific date, at a specific time. By way of illustration, the user may specify that the date the user is willing or interested in attending is a Laker v. Clipper game (without specifying which date or time), or may specify that the date the user is willing or interested in attending is a Jan. 14, 2014 Laker v. Clipper game at 8:00 PM at the Staples Center. The user may also post an expiration date/time for the date posting, wherein if the date is not accepted by the expiration deadline, the date is to be delisted and no longer considered available.

A user may also specify date payment terms. For example, the user may specify that the user is willing to pay expenses for both parties to the date (e.g., for a meal at a restaurant, tickets to a ticketed event, etc.), or that the user expects that the other party will pay for both parties to the date, or that the user wants each party to the date pay for their share of date. Thus, colloquially, a user may specify that the user will treat the other date participant, expects to be treated by the other date participant, or each participant will pay their own way. Similarly, a user may in addition or instead specify that the user will pay a system related fee for the other date participant (e.g., a fee for issuing a date invitation for the date), or that the user expects the other date participant to pay a system related fee on behalf of the user (e.g., a fee for posting the date).

The user may also specify if one or more people (e.g., friends of the user who will act as “wingman” providing moral support and safety for the user) will be accompanying the user on the date.

Once the user has completed specifying the date, the user may activate a posting control provided via a user interface, and the date posting is recorded in a data store. The date posting may then be searched for, and viewed by others as described elsewhere herein. The date posting may be displayed to other users in association with an invite control, where other users can invite the posting user to go on the posted date by activating the invite control. The posting user may then accept or decline the invitation. Optionally, the inviting user may specify an invitation expiration time (e.g., a date and time, or a number of hours or days from the time the invitation is issued) indicating how long the posting user has to accept the invitation, wherein if the invitation is not accepted before the specified expiration time, the invitation will expire and may no longer be accepted. This feature may encourage the posting user to accept the date quickly, thereby resulting in more dates between users. Optionally, as discussed elsewhere, the inviting user may issue multiple invitations to several users that have posted substantially the same date, wherein the first user that accepts the invitation will get to go on the date, and the invitations to other posting users will then automatically expire and can no longer be accepted. This feature may also encourage the posting user to accept the date quickly.

Optionally, if the posting user declines the invitation or does not respond to the invitation within a specified period of time, in response to detecting the foregoing, the system may identify to the inviting user similar posted dates and/or posting users, enabling the inviting user to issue an invitation to one of the suggested similar dates/posting users. This feature may encourage the inviting user to quickly invite another user on a date, and reduce the disappointment at not having the first invitation accepted.

Optionally, rather than having to specify a date posting from scratch, a user may be able to copy and edit a previously posted date, and then post the copied and edited date. This technique may be useful to users, such as users that do not know where or when they wish to go out on a date. For example, when a user views search results for dates that have already been posted (e.g., the results of user text searches, searches conducted to identify dates posted for the current calendar day, or searches conducted to identify popular dates, as described elsewhere herein), the user may see a posted date for an event (coffee at Acme Café, dinner at Acme Dinner, an Adele concert) that the user would like to attend, but may not identify an individual who has posted the date the user would like to invite on the date. Instead of abandoning going on a date to the event, the user can activate a copy control provided via a user interface, and a copy of the date posting will automatically be presented to the user in an editing interface which provides the user with the ability to edit the posting. The user may then change some or all of the date parameters, and post the edited date so that others can view the user's posted date and invite the user to go on the date. The optional date copying feature simplifies the date creation/posting process and provides an alternative method for user to express an interest in an event without inviting another member out on the date.

A date posting may be treated as an expression of interest in going on the specified date, but not an invitation to others that they may accept to establish the date. In other words, the posting user is optionally not obligated to go on a date posted by the user. Instead, another user viewing the posting may express an interest in going on the posted date (e.g., by sending an invitation to the posting user), and the posting user may decide whether or not to go on the date with such user, and activate an accept control to accept the invitation, and optionally a decline control to affirmatively decline the invitation.

Optionally, the system enables a user to post multiple dates via a calendaring system. For example, a user may post 81 dates, one for each local baseball team home game. Optionally, a user needs to manually specify that an invitation is to be sent to a specifically selected posting user, and the system will not automatically send out invitations, and will not automatically send invitations to prospective participants to a date. This provides users with enhanced control over the invitation process.

The user may optionally also provide, via an optional interface, user characteristic data (e.g., profile data) and the desired characteristics in a potential dating partner, which is recorded by the system in association with the user's account. For example, the user may specify some or all of the following: the user's gender, age, sexual orientation, education level, type of car owned, income level, profession, physical characteristics (e.g., height, weight, color hair, color eyes, physical condition, etc.), religion, political affiliation, location (e.g., address, city, neighborhood, region, etc.), race, marital status, drug and drinking habits, self-defined-type (e.g., hipster, sophisticate, music lover, athlete, casual, etc.), contact information (e.g., email address, cell phone number, home phone number, instant messaging address), etc. Similarly, the user may specify such characteristics desired in a potential date. The system may enable the user to upload one or more photographs of the user or other subjects. Optionally, photograph editing tools may be provided (e.g., to crop out extraneous portions of a photograph). The user interface may also be configured to receive from the user a narrative self-description, where, for example, the user can optionally describe his or herself, and what they are looking for in a relationship and potential date.

Optionally, the user interface may enable the user to specify favorite date types and/or venues (e.g., loves to meet for walks, favorite specific restaurants for dates, favorite restaurant-types for dates (e.g., That restaurants), favorite specific bars for dates, favorite sporting events for dates, etc.). Some or all of the foregoing user-provided data may be stored by the system in association with a user profile/account.

Optionally, a user interface (e.g., provided by the system or a phone app) may enable the user to indicate which items of the user's profile may be shown to other users, and under what circumstances such user profile information may be shown. Optionally, the system may provide the user with a control via which the user can indicate whether the user wants their dating system profile data to be synchronized with profiles of the user on one or more user-specified other sites (e.g., social networking sites, microblog sites, etc.). If the user indicates the user wants to synchronize the user's profiles, the system will then access profile information from and provide to the selected other sites.

Once a user has posted a date, the dating system may then identify matching other users that have indicated they are interested in or willing to go on a date with the same date specifications (and/or optionally with similar date specifications). For example, the dating event may identify other users that have specified (e.g., via a date posting of their own) that they are willing to go on a date with the same event category, at the same event location, and at the same event date(s)/time(s). For example, the other users may have posted such a date or created a date filter to identify such a date.

Optionally, the system may then present some or all of the matching users to the user. Optionally, the presented matching users may be filtered based at least in part on the user characteristics and/or some or all of the desired characteristics specified by the user, examples of which are described elsewhere herein. For example, if the user specifies that the user is interested in women, with a height between 5′2″ and 5′5″, that live or work within 5 miles of the user's location, the system will filter the presentation to present women with such criteria that have matching date specifications (e.g., as reflected in a date posting by such potential date partners or by a filter set up by such potential date partners). Optionally, not all of the user specified criteria need to be met in order for another user to be identified as a potential date partner. Optionally, the filtering can be performed in whole or in part in response to a user instruction after an initial list of users with matching date specifications are presented to the user. Optionally, some or all of the user characteristics and/or desired characteristics are not used in performing the filtering (e.g., political affiliations, hobbies, etc.).

Optionally, partial matches may be identified and presented by the system. For example, posted dates that match the user's posted date, except that a specified item is slightly different (e.g., the calendar day is slightly different (e.g., 1 or 2 days before or after the date specified in the user's posted date), or the location is slightly different, or is slightly outside a specified geographical area) may be identified and presented to the user. Optionally, partial matches are presented only if there are no full matches. Optionally, partial matches are presented even if there are full matches, but the partial matches are distinguished by being placed lower down in the match results, via color coding, text, an icon, and/or otherwise distinguished.

Information regarding the presented users with matching/similar date specifications may also be provided. For example, some or all of the characteristic information provided by the presented user that the presented user indicated may be provided to others, such as age, hair color, eye color, height, etc., may be presented. Such information may be retrieved by the dating system from an account data store record for the presented user.

The user can then select which of the presented users with matching date specifications the user is willing to go on the date with. The selected user may then be notified that the user is interested in going on the date (with the matching date specifications). The selected user may be presented with some or all of the characteristic information provided by the user that the user indicated may be presented to others. In addition, some or all of the date specifications of the user may be presented to the selected user in conjunction with the notification (e.g., date category(s), location(s), date(s), time(s), etc.). If the selected user indicates (e.g., by activating an accept invitation control) a reciprocal interest in going out with the user (on the date with the matching date specifications), the user is so notified.

At least partly in response to the interest indicated by the selected user, a communication channel is optionally provided via which the user and the selected user can coordinate their date if so desired. For example, the communication channel may be a text messaging, voice, and/or video call channel, enabling the user and the selected user to communicate in real-time. Optionally, the user and/or selected user may select which communication channel they want to use via a menu of communication channels. Optionally, the system records a record of the communication(s), for later retrieval and playback/review by the user, the selected user and/or a system administrator (e.g., to review compliance with usage guidelines, to ensure that safety of participants, etc.). The system may then report some or all of the monitoring results, optionally broken down by user type(s) or otherwise.

The date-centric approach described herein enables the pairing/matching of users who have a general idea of where to go or what to do for a date, but do not have a specific location in mind. For example, a user may post a date indicating that the user is interested in going to a bar or coffee shop in a particular neighborhood. By way of illustration, if the user expresses an interest in coffee shops located in Culver City, the system optionally:
identifies and sends to a terminal of the user pictures/profile information of individuals who have posted dates for coffee shops in Culver City, or
sends to the user terminal information regarding the dates, or
sends to the user terminal both pictures/profile information of the individuals that posted the dates, and information regarding the actual date.

Information regarding a date can be broken down into discrete dates and/or can be combined together in an aggregated list. For example, all coffee shop dates in Culver City can be broken down individually by date, time location etc., or such dates can be combined into logical groups. By way of illustration, dates for the Ace Coffee shop on Washington and Overland in Culver City may be grouped together, and dates for Beta Coffee may be group together, etc.

Optionally, certain embodiments enable users to bypass the traditional invitation/acceptance model of conventional dating sites. For example, as similarly discussed above, if the system determines that two or more users have posted a similar date for an event, the system may automatically, or in response to user instructions, transmit profile information (optionally including photographs) to such users, enabling the users to indicate if they would to attend the event with another user. As similarly discussed above, optionally each user has to indicate they are interested in going on the date with the other user in order for there to be a match. If only one user indicates that they are interested in going on the date, no date will be created. For example, assume that a user “Sara” wants to go to an Adele concert on Sunday night. If there are 10 individuals that are also interested in going to the Adele concert, Sara will receive from the system their photos/profiles, and these 10 individuals will receive Sara's photo(s)/profile. Sara can express positive interest in one or more of the individuals and one or more of the individuals may express positive interest in Sara, and such expressions are received and stored by the system. Optionally, neither party is informed of a match unless both parties express interest. A date may be created with the first matching pair.

Certain embodiments enable users to assume the rolls of host and guest, where a host is a user that agrees to pay for both parties to a date and a guest is the treated party to the date. Optionally, the host may extend a date invitation to a potential guest, and the potential guest may accept or decline the date. As similarly discussed in greater detail elsewhere herein, optionally a user can search for date postings where the posting user has agreed to be a host.

Optionally, a user may issue several invitations, optionally at substantially the same time, to respective different users that have posted dates for the same event, where the first posting user to accept the invitation “wins”, and is matched with the user to go on the date. Optionally, the number of invitations a user may send for a particular event may be limited to a certain threshold (e.g., 2, 5, or 10 invitations).

For example, often there will be a number of individuals that have posted similar or identical dates for a particular event or venue (coffee at the Acme Cafe, an Adele concert, a particular movie), which may be at a specified time. The system enables a user to invite out more than one of these individuals (via their respective date postings) for the particular event or venue. For example a user may invite several other individuals to an Adele concert. In response to the user activating a corresponding “invite” control, the system will transmit to the respective individuals' terminals an invitation (where optionally each recipient receives a respective invitation, which may optionally be unique and have unique decorative features) to the event. The invitation may optionally also indicate that other individuals have also been invited on the same date and that the first individual to accept the invitation will be the individual that goes on the date. This efficient technique enables users to “invite” more than one person to an event, and so increases the likelihood the user will actually go on the date. In addition, because the individuals have been invited to the event (e.g., the Adele concert) know that others have also been invited, there is an incentive to act quickly and accept the invitation (where the acceptance may be transmitted back to the system and on to the user posting the date).

Because the system keeps track of invitations and acceptances, the system automatically knows the identity of the first individual to accept the invitation. The system may also detect and notify other individuals who later accept the invitations that they have responded too late, and that the date is no longer available (optionally, such a notification may be sent substantially as soon as someone accepts the date). Individuals that have missed on the particular date opportunity because of a slow response to the invitation will be incentivized to respond more quickly the next time they are invited out.

Further, because the system tracks and records date postings and acceptances, the system may process such information (e.g., to determine which events/locations/days are popular for dates) and may provide useful related information to users of the system. For example, the system may access date posting information to determine the relative popularity of days for dates. Optionally, using such information, the system may display a calendar for a given week, month, or other time period, with a given day in the calendar coded (e.g., color coded, icon coded, text coded, etc.) to indicate the relative popularity among system users of the given day for a date. By way of further example, if a user is searching for a date at a specific location, the system may determine from stored active date postings which days and/or times are the most popular for date postings for that location and/or rank the relative popularity of dates and/or times (e.g., based at least in part on the quantity dates posted for the location on a given day and/or time).

If color coding is used to reflect popularity, optionally the color or the deepness of shade or intensity of color may be used with respect to the calendar to indicate popularity. Thus, the system may generate and provide for display a form of heat map indicating popularity of calendar days for dates. For example, days that have relatively more posted dates for a venue may be displayed by progressively deeper shades of color, where the day with the greatest number of posted dates for the venue may display the darkest shade and the date with the fewest posted dates will display the lightest shade. Optionally in addition or instead, the system may display a number that indicates the number of posted dates for the location or event for a given calendar day.

The system may provide a user controllable filter interface when viewing the calendar for a specific event, category, or keyword, which enables the user to narrow or expand the number of posted dates displayed to the user by specifying desired filter conditions. The filter may be used to filter the profiles of individuals being presented to the user that the user may potentially be interested in inviting on a date. For example, the filter may enable the user to specify filter criteria including, by way of example, and not limitation, sex, age, religion, marital status, income, profession, education, physical characteristics, drug and drinking habits, and/or other characteristics of a potential date partner.

Optionally, a search engine may be included in or accessed via the system which enables a user to search for dates specified by other users. Optionally, the user may be able to specify one or more search filter conditions (e.g., event category(s), location(s), date(s), time(s), tags, who is to pay for date and/or who is to pay a system fee for posting date or for issuing an date invitation (e.g., the user can specify that the system is to search for posts where the posting user agrees to pay for the date and/or posting user agrees to pay for the system fee associated with inviting the posting user on the date), etc.). Optionally, the search feature may be disabled by the system for a given user if the system determines that the user lacks one or more eligibility criteria to utilize the search feature. For example, a user may optionally be required to post and/or go on a specified number of dates (e.g., 1 date, more than 1 dates, 3 dates, or other number of dates) prior the system enabling the user to access to the search function and/or certain enhanced search function features (e.g., the search filter feature). Optionally, the user does not have to post any date in order to utilize the search engine and perform searches for posted dates. Optionally, the user may be charged a separate fee to use the date search function (e.g., 10 cents/search, 50 cents/day, etc.).

If an eligible user enters a date search query, then the system may identify active posted dates (e.g., dates that have not expired or for which an invitation has not been accepted) that match or substantially match the date search query (e.g., by accessing and analyzing posted date information stored in a system data store, such as a database), and may present some or all of the identified active posted dates to the user. The user may then select one or more of the presented dates, view additional information regarding the date and/or posting user (as similarly described elsewhere herein), and indicate whether or not the user wants to go on the selected date (e.g., by issuing an invitation), as similarly described elsewhere herein.

Optionally, the system may be configured to monitor site use, frequency of use, time spent on site, and other statistics for each user, a subset of users, and/or all users in the aggregate to facilitate determining which dates or types of dates are popular and/or to select advertising promoting a popular date location, wherein the advertising may be presented to users interested in going to dates in the area of the popular date location.

Optionally, the dating system may track and report trends. For example, the system may monitor which date types, locations, days, and/or times are being specified by users in general, and/or for specific user types. For example, the system may monitor which date types, locations, days, and/or times are being specified by women, by men, straight users, gay users, by users within a specified age range (e.g., 18-22, 22-29, 30-35, 35-40, 40-50, 50-60, etc.), within a specified location (e.g., within a specific city, neighborhood, zip code, etc.), having a specified range of income, having a specified profession, by self-defined type(s) (e.g., hipsters, sophisticates, music lovers, athlete, casual, etc.), and/or by type assigned by the system (e.g., hipsters, sophisticates, music lovers, etc.), and combination of user types (e.g., women between the age of 22-29, that are self-described as a hipster), etc.

Optionally, the system may process the monitoring results further to identify (and optionally report to users, administrators, advertisers, etc.) certain information that may be of particular interest. For example, the system may determine a certain number (e.g., 10) of the most popular event categories, locations, dates, and/or times, specified by certain types of users, such as women between the ages of 22-30 in West Hollywood, Calif. This information may, for example, be presented to men between the ages of 22-30 in West Hollywood, Calif. that have indicated they are interested in dating women. Such men may then specify and post dates with similar characteristics, making it more likely that the posted date will be of interest to women between the ages of 22-30 in West Hollywood, Calif., and hence more likely that such women will be presented with and agree to go on the date (e.g., by sending an invitation to the posting user which the posting user may or may not accept at his discretion). Optionally, the most popular date information presented to a user may be modified if the user selects a different geographical area or otherwise specifies different user characteristics. Optionally, the most popular date information may be updated in substantially real time as new date postings are received by the system (e.g., within 1 second, 10 seconds, 1 minute, 10 minutes, 1 hour, or other time frame with respect to a new date posting).

The system may identify the most popular dates and/or users that have posted dates that correspond to the most popular dates in a popular date user interface, which may be provided on, or accessible via a user's dating system home page and/or elsewhere. A viewing user may view the listing of the most popular dates, view information regarding users that have posted dates that correspond to the selected most popular date, and then optionally select a date posted by a specific user. By way of illustration, the ten most popular dates may include brunch at Acme Café on April 30, a Dodger game on April 29, etc. If the user selects the April 29 Dodger baseball game date, the system may display information regarding some or all of the users that posted the date for the April 29 Dodger baseball game. Optionally, the display of the posting users may be filtered and/or ordered in accordance with the viewing user's specification of characteristics desired in a potential match and/or the posting users' specification of characteristics desired in a potential match, as described elsewhere herein. The user can then select a posting user and indicate that the user is interested into going on the April 29 Dodger baseball game date with the selected posting user.

Optionally, the system may automatically identify to a viewing user other users that have posted dates that are scheduled to take place on the current day (or other specified time period, such as the current week or the next 3 days) within a given geographical area (e.g., within a specific city or neighborhood of a viewing user), sometimes referred to herein as “daily dates”. Optionally, the daily date information may be updated in substantially real time as new date postings dates on the current day are received by the system (e.g., within 10 second, 1 minute, 1 hour, or other time frame with respect to a new date posting for the current day). The daily dates user interface may be presented on the user's home page and/or elsewhere.

The daily dates user interface enables a user to quickly identify dates that are available on short notice. A viewing user may view the cumulative listing of the dates that are scheduled to take place on the current day, view information regarding the respective posting users, and then optionally select one or more dates posted by respective users. By way of illustration, dates that are scheduled to take place on the current day may include dinner at Acme Diner, a Lakers basketball game, etc. If the user selects the Lakers basketball game date, the system may display information regarding some or all of the users that posted the Lakers basketball game date for the current day. Optionally, the display of the posting users may be filtered and/or ordered in accordance with the viewing user's and/or the posting users' specification of characteristics desired in a potential match, as described elsewhere herein. The user can then select and indicate (e.g., by issuing an invitation) that the user is interested into going on the Lakers basketball game date for the current day with the selected posting user and the selected user is so notified and may accept or decline the date invitation. If the user extended an invitation to multiple posting users for the same day at the same time or time range, then once a posting user accepts the invitation, the other invitations are cancelled, and the other posting users to whom the invitation was sent are so notified, as similarly discussed above.

Optionally, the system may prompt the user each time (or the first time on a given day) the user accesses the system to indicate if the user is available for a date that day to further encourage users to date.

The daily dates and/or popular dates listings may be ordered and/or filtered using one or more criteria. For example, the daily dates and/or popular dates listings may be filtered to show the most popular dates in a defined area (e.g., a city) or a subarea (e.g., a neighborhood within the a city), and the listing may indicate which activities/events are trending up or down in popularity (e.g., based on the number of corresponding postings, the number of issued invitations, and/or the number of accepted invitations).

The listings of activities/events can be ordered by event name, venue name, keyword, by category, or by time. As similarly discussed elsewhere herein, the daily dates and/or popular dates listings can be further filtered by gender, age, religion, marital status, income, profession, education, physical characteristics, drug and drinking habits and/or other criteria, optionally including other criteria discussed elsewhere herein. The user may then extend an invitation to one or posting users whose posted date remained in the search results. As similarly discussed above, if the user extended an invitation to multiple posting users for the same event, then once a posting user accepts the invitation, the other invitations are cancelled, and the other posting users to whom the invitation was sent are so notified.

Thus, for example, a user that does not know or is uncertain as to what dates to post or does not have a strong preference as to a date activity can access the popular dates or daily dates user interfaces to view respective cumulative lists of popular dates and date posted by other users for the current day.

Optionally, a user may specify one or more favorites date activities or venues, without having to post a date, or specify a calendar day and/or time for a posted date. By way of example, if a user has several favorite bars or restaurants that are located in the vicinity where the user lives, the user can determine the respective name, location, telephone number and categories for such favorite bars or restaurant (which may be optionally accessed via an API as discussed elsewhere herein). At the same time the member can post dates for such favorite bars or restaurants, and can designate them as “Favorites”. By way of further illustration, a user may specify that dinner at the Acme Grill is a favorite date location and activity. The system may then display to the user, on the user's dating system home page or elsewhere, a favorite date section, which provides access to a cumulative listing of matching posted dates. For example, the user can click on or otherwise select the favorite date section, and the system will search for and identify dates (or used stored search results) that other users have posted at that venue and/or for that event, optionally without reference to the day and/or time for the posted dates. The user can then select and view one or more of the posted dates (including the specified date(s)/time(s)), view information regarding the posting user of the selected posted date, and indicate whether the user is or is not interested in the posted date, as similarly described elsewhere herein. A filter may be provided that enables the user to specify filter criteria including, by way of example, and not limitation, sex, age, religion, marital status, income, profession, education, physical characteristics, drug and drinking habits, and/or other characteristics. Thus, using the “favorites” process, the user does not have to constantly post dates for the user's favorite date, but can instead, conveniently provide a single favorite date specification for a favorite event or venue, and at the user's leisure can view corresponding posted dates.

Certain embodiments optionally provide a fast match feature (sometimes termed herein an “instant match”), which may optionally be accessible via a user's home page. The fast match feature provides a quick centralized mechanism that enables a user to quickly check on each date that has been posted by the user. For example, if dates have been posted to 5 Lakers Games, 5 Dodger Games, 5 different restaurants and 10 different bars, the potential matches identified by the system can be easily and quickly reviewed in one location.

Optionally, the dating system may enable users to make reservations at and/or purchase tickets for a date location/event. For example, if a user posts a date for a given location, at a specified date, and time (e.g., brunch at the Acme Café, on Apr. 19, 2013, at 11:00 AM), the system may present a reservation form for Acme Café (which may optionally be accessed via an API as discussed below), optionally prepopulated by the system to correspond to the date venue, date day and time, and/or number of attendees (e.g., to indicate that the reservation is for the Acme Café, for two people, on Apr. 19, 2013, at 11:00 AM), as specified in the date posting. Optionally, the system may enable the user to modify the prepopulated information, or if certain or all the information is not prepopulated, to enter the corresponding date day and time, etc. The user may then activate a booking control to book the reservation and the date location/venue is notified of the reservation (e.g., via the API). Similarly, if the date is for a movie (e.g., the Great Train Robbery, at Acme theaters, on May 1, 2014 at 8:00 PM), the system may enable a user to purchase tickets for the movie.

Optionally, the reservation form/ticket purchase may be provided by the date venue (e.g., the Acme Café) or via a third party reservation/ticket purchase service, optionally accessed via an application program interface (API). Optionally, the reservation/ticket purchase form is presented when the user is posting the date and/or after the date has been accepted by another user. Optionally, a fee is paid to the dating system operator with respect to the reservation/ticket purchase by the date venue, the third party reservation/ticket purchase service, and/or one or more of the users participating on the date. Optionally, a fee is paid to the dating system operator at least partly in the response to the reservation being made. Optionally, a fee is paid to the dating system operator at least partly in the response to determining that the reservation was actually utilized (e.g., the user and the user's date attending the venue as indicated by the venue).

An API may be provided to other sites and data sources as well, such as event/venue review sites, via which event/venue review information may be accessed, some or all of which may be displayed to users. Because data is accessed via an API from a venue or event system, the use of such APIs may reduce or eliminate the possibility of errors with respect to the spelling or entry of a venue, event or activity name/identifier; the specific address of venue, event or activity; the date or time of the venue, event or activity; the telephone number of the venue, event or activity; the cost or cost range for the venue, event, or activity; the correct category for the event (e.g. sports, concert, play, restaurant, bar, night life). In addition, optionally an API may be used to access (and provide to the user) a map showing the precise location of a venue or event.

For example, an initial posting for a Dodger game on Jul. 29, 2013 by a user may include information populated by the system using data accessed via an API from a reliable source's database, such as an authorized ticket seller for the event. Because the reliable source's database typically has the correct spelling, date, time, telephone number and location for Dodger games, as well as the correct category and the price for tickets, seat information, the initial date posting for the Dodger game on Jul. 29, 2013 will include the correct information regarding the foregoing. Optionally, subsequent postings by other users for the Jul. 29, 2013 Dodger game can be made by re-accessing information from the source's database using the API, or by utilizing and replicating the information regarding the Dodger game previously retrieved for the first posting for the new posting.

Optionally, the user does not need to specify a day and/or time for an event being posted, but instead just specifies an event identifier. For example, the user may specify that the event is a Bruins v. Trojans football game, and the system may access the date and/or time information for the game via the API from a reliable source (e.g., a ticket seller database), which will locate the information using the event identifier. An API may be used to access a variety of other types of information for a venue or event. For example, for a restaurant or bar, an API may be used to access information regarding the type of food, the cost, the ambiance, reviews etc. This information may optionally be provided to a user prior to the user posting the date to determine whether the user does or does not want to post the date based at least in part on such information accessed via the API and presented to the user.

Some or all of the data accessed via an API may also be used as tags/metadata stored in association with a date posting. Such tags/metadata may be used to identify matches when performing searches. For example, for the Acme Café restaurant, the tags may indicate, based on information accessed via the API, that the restaurant is expensive, Italian, and located in Beverly Hills, Calif. If a user then searches for an expensive restaurant located in Beverly Hills or for a posted date taking placed at an expensive restaurant located in Beverly Hills, the search may identify, based on the API-derived tags, the Acme Café (or dates for the Acme Café) in the search results.

Certain embodiments enable a user to search for date events using an electronic map. For example, a user may specify certain date criteria (e.g., sushi restaurants in a specified price category). The user can then select (e.g., via touch or via a mouse) a region of the map, and the displayed map will be zoomed to magnify the selected area and/or provide an icon, text, or other indicator indicating venues that match the date criteria. Certain embodiments enable a user to search for date postings using an electronic map. The user can select (e.g., via touch or via a mouse) a region of the map, and the displayed map will be zoomed to magnify the selected area and/or provide an icon, text, or other indicator indicating date postings for date to occur in the selected area.

Certain embodiments provide an API to the dating system that enables date venues, such as restaurants, movie theaters, or service providers for date venues, such as ticket sites, to provide users with access, via the venues' networked sites (e.g., websites), to some or all of the functionality provided directly to users by the dating system, such as the functionality described elsewhere herein. Thus, for example, the API (providing an interface to the dating system) may access from the dating system date postings for a given date venue (e.g., optionally only active postings that have not expired) and provide such postings to the system hosting the venue site, and the venue site may then display some or all of the date postings.

Users visiting the venue's website or accessing data via the venue's site (e.g., via a browser or a dedicated application, such as phone application or “app”) can then view the date postings, and can issue invitations to the date poster, as similarly described elsewhere herein. Optionally, such invitations may be transmitted from the venue operator's site to the dating system, which may then relay the invitation to the user that posted the date, as described elsewhere herein. Optionally, users may also be enabled to post dates via the operator's site, and the date posting is then communicated to and stored by the dating system. This technique will further encourage users to go on dates, and may benefit the venue operator as the dates are more likely to occur at the operator's venue(s).

Optionally, the venue operator can specify (e.g., via a user interface provided for display by the dating system or otherwise) what type of information is to be provided by the dating system via the API. For example, the venue operator may specify that only date postings for the venue are to be provided. If, for example, the venue operator operates multiple venues (e.g., a coffee shop chain), the venue operator can specify that only date postings for venues of the operator in the neighborhood of the user accessing the venue operator's site are to be provided. By way of illustration, the user's location may be estimated or determined by the operator's site and/or the dating system based on location information provided by the user's internet protocol address, by GPS, WiFi, or cell tower information provided by the user's terminal (e.g., a mobile cell phone), via information provided by the user (e.g., when registering for an account with the venue operator or the dating system), or otherwise. At least partly in response to the venue operator's specifications (which may specify a city, neighborhood, area code, distance, etc.), the dating system may then identify venues of the venue operator within the same area code, neighborhood and/or city as the user, or within a specified distance from the user, and provide active date postings for such identified venues. Thus, users in different locations accessing the venue operator's website may be presented with different date postings, even when viewing the operator's website from their respective terminals at the same time.

Optionally, the dating system may identify and provide all date postings (or all active date postings) for the venues operated by the operator, and the operator system can filter the date postings and display the postings that meet the operator's filter conditions (e.g., display only date postings for the operator's venues within 5 miles of the user).

Optionally, the API may enable users to conduct searches for date postings, as similarly discussed elsewhere herein, wherein the searches are conducted via a search interface presented via the venue operator's site. Optionally, the search engine will only return date postings specifying the operator's venue(s). Thus, the search engine may be configured to automatically filter out date postings for venues owned by a different operator from the search results, prior to providing the search results for display to the user.

Optionally, instead of or in addition to providing an API to enable the operator to receive data from, and provide data to the dating website, a link (which may appear as text and/or as an icon) may be provided via an interface (e.g., a webpage) presented by the venue operator's site, which can activated by the user (e.g., by clicking on or touching the link), causes the user's browser or other application to be navigated to an interface hosted by the dating system (e.g., a user's home page as described elsewhere herein). The interface hosted by the dating system may optionally be branded with the venue's brand and/or may be configured to appear as if it were part of the vendor's site. This technique may, in certain circumstances, be easier for the venue operator to implement as compared to the use of the API.

Optionally, the dating system may present advertisements to a user based at least in part on the user's characteristics (e.g., gender, age, religion, political leanings, hobbies, location, etc.) and/or on some or all of the specifications of a date(s) posted by the user and/or on some or all of the specifications of a date(s) accepted by the user. For example, if a date specifies that the date is for a walk on a beach boardwalk, the system (or a third party advertisement server system or other system) may select one or more advertisements for one or more venues (e.g., coffee house, restaurant, bookstore, etc.) on and/or adjacent to (e.g., within a specified distance from) the boardwalk. Optionally, the system operator may be paid for the presentation of a given advertisement by the advertiser and/or an ad server operator.

Optionally, the system may host one or more blogs accessible by users. For example, the system operator may host a blog that describes new features, publically addresses complaints about the system, provides information on how many dates users have gone on in a given period of time, etc. Optionally, the system may enable a given user to maintain and edit their own blog, which may be hosted by the system and may accessible to other users.

Certain embodiments optionally do not require subscription fees to be paid in order to utilize features of a dating system (although optionally subscription fees may be charged). Rather, a user may pay a fee for dates actually facilitated by the system (e.g., arranged and/or completed). For example, the user (and/or the other date participant) may pay a fee (e.g., optionally a small fee, such as about $1.00, $2.00, or other amount) for each date the user posts, for each date to which a subscriber agrees to participate in, and/or for each date which actually takes place. Optionally, the user is not charged for posting a date but is charged if the user actually accepts an invitation to go on a date or has an invitation accepted to go on a date. This approach greatly lowers the financial barrier for utilizing the dating services, as the user does not have to commit to paying a periodic fee. Further, users are more likely to use such embodiments of the dating system as they only need to pay if they are successful in arranging a date.

Optionally, if one user or both users that have agreed to go on a date indicate that the date was cancelled (e.g., via a user interface provided by the dating system or via a dedicated application, such as a phone app), the cancellation indication is received and stored by the dating system, and the fee paid by the user(s) is refunded (e.g., credited to the user's account). Optionally, if a user cancels more than a threshold number of dates or more than a threshold number of dates over a specified period of time (e.g., 12 date cancellations in a year) as determined by the dating system from the stored data cancellation indications, the user will not receive further refunds via the dating system or from the dating system operator for future cancelled dates, and the user may be so notified by the system. Optionally, subsequently to the user being prevented from receiving further refunds for date cancellations, if the system determines from the stored data cancellation indications that the user has cancelled less than a threshold number of dates in a subsequent period of time (e.g., correcting their past bad behavior with respect to cancelling dates), the system may enable the user to again receive refunds for cancelled dates.

Certain example embodiments will now be discussed with reference to the figures.

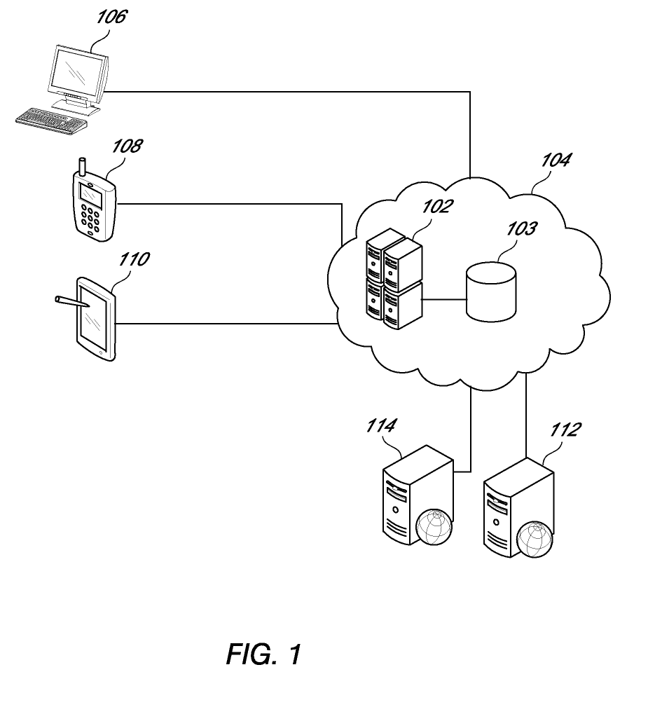

Referring now to FIG. 1, an example system architecture and environment is presented. An example dating system 102 (which may be optionally cloud based) includes one or more servers and one or more data stores 103 (e.g., databases). For example, the date stores 103 may store user account information (e.g., name, contact information (e.g., email, wireless phone number, physical address/location, etc.)), profile information, date postings and related information, date posting result information (e.g., was a given date accepted and/or completed, did the date posting expire without the date being accepted and/or occurring, etc.), user-defined date filters, date search queries of a given user, an identification of posted dates viewed by a given user, etc. The dating system 102 may be coupled via a network 104 (e.g., a wired and/or wireless network, such as wide area network (e.g., the Internet), an intranet, or other network) to one or more user terminals 106, 108, 110 which may be associated with users posting and/or accepting dates. The dating system 102 may also be coupled to one or more third party reservation systems 112 and/or one or more advertisement server systems 114. The dating system 102 may perform some or all of the functions described herein.

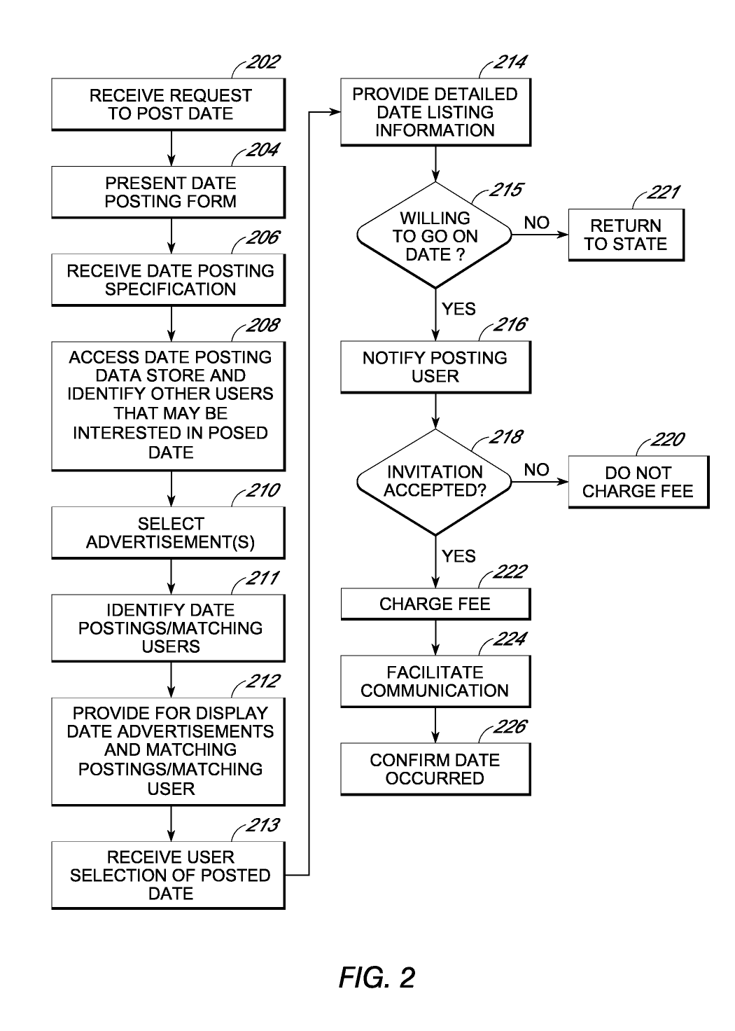

FIG. 2 illustrates an example dating process. As noted elsewhere herein, the process may include fewer or additional states, and the states may occur in a different order. At state 202, a dating system receives a user request to post a date. At state 204, a date posting form is provided for display on the user's terminal. As similarly discussed herein, the user may specify the date (e.g., date event category/type, date event location, date event time, who pays, deadline to accept date, etc.) via the posting form. At state 206, the system receives and stores the user's date specification. At state 208, the system identifies other users that may be interested in the posted date. For example, the system identify other users that have posted dates with the same and/or similar specifications, that have defined a filter to locate dates with the same and/or similar specifications, that have searched for dates with the same and/or similar specifications, etc. At state 210, the system and/or a third party advertisement server selects advertisements, optionally based at least in part on the date specification and/or on certain characteristics of the user. Optionally, the system transmits some or all of the date specification and/or certain characteristics of the user (optionally anonymized to obscure the identity of the post user) to the third party advertisement server to enable the third party advertisement server to select correspond, appropriate advertisements.

At state 211, the system identifies to the posting user other date posting(s) that match that of the posting user, as similarly described elsewhere herein. At state 212, the system provides the selected advertisements and matching postings to the user. If the user selects one of the matching posted dates, then at state 213, the system receives the selection of the matching posted date. At state 214, the system access and provides for display detailed information regarding the selected posted date. For example, the system may provide information regarding the date location, date, time, whose paying, etc. and/or characteristic information that the user that posted the selected date indicated may be shared with others. For example, a user may wish to be anonymous and so may specify that the user's actual name is not to be displayed in a date listing.

At state 215, the system receives an indication from the user as to whether the user is willing to go on (or considering going on) the selected posted date. If the user indicates the user is not interested in the selected posted date (e.g., by activating a “not interested” control, by navigating away from the selected posted date, or otherwise), the process may return to state 211, and the user may select another posted date. If the user indicated an interest in going on the selected posted date (e.g., by activating an “interested” or “invite” control or otherwise), at state 216 the user that posted the selected post date is so notified. For example, the posting user may be notified of the viewing user's interest by transmitting the invitation to the posting user by email, SMS, MMS, a dedicated phone application, a page presented in a browser, or otherwise.

At state 218, a determination is made as to whether the posting user accepted the invitation. Optionally, if the posting user did not accept the invitation to go on the date, the process proceeds to state 220, and the user(s) are not charged a fee with respect to the date. Optionally, if the posting user did accept the invitation to go on the date, the process proceeds to state 222, and the user(s) are charged a fee with respect to the date.

At state 224, a user interface is provided enabling the user and the invited posting user to communicate (optionally directly) to coordinate the date. For example, the system may provide a text, voice, and video-voice chat/call capabilities enabling the users to communicate in real time to coordinate the date as needed or desired. At state 226, the system optionally confirms whether the users actually went on the date (e.g., based on input from one or both users, from the venue the date took place, or otherwise).

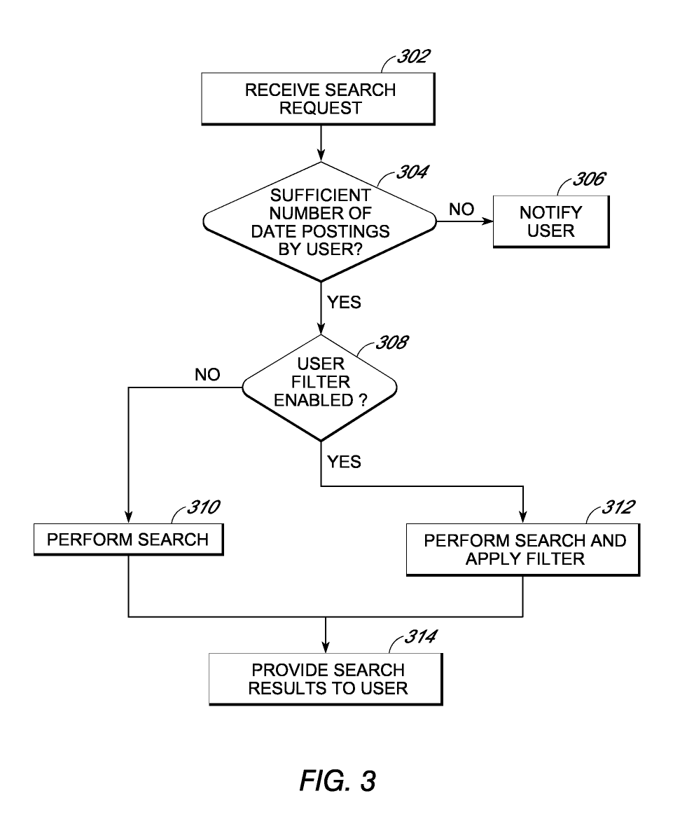

FIG. 3 illustrates an example date search process, which may optionally be performed using system 102 illustrated in FIG. 1 and optionally with a third party search system (which may be hosted on one or more remote servers). At state 302, a search request is received from a user via a user terminal. For example, the search request may be in the form of a text query including one or more search terms entered by the user into a search field and/or may be in the form of a filter where the user checks off desired and/or not desired date characteristics. Optionally, the system 102 may be configured to disable or limit a user's ability (e.g., limit the number and/or type of search terms or search tools) to perform a search for a date unless the user has posted at least a threshold number of dates and/or based on other criteria. In such an embodiment, at state 304, a determination is made as to whether the user has posted the threshold number of dates (which may be time limited, in that the user needs to have posted a threshold number of dates within a specified period of time, such as the last year or other time period). If a determination is made that the user has not posted a sufficient number of dates, the process proceeds to date 306, and the user is so notified. The system may be configured to determine and identify to the user how many more dates the user needs to post in order to utilize (or fully utilize) the date search facility, to thereby encourage and incentivize the user to post dates. Optionally, the determination as to whether the user has posted the threshold number of dates is posted before enabling the user to submit a search query (e.g., where a search field is shown in a greyed-out state to indicate that it is not functional).

If, at state 304, a determination is made that the user has posted the threshold number of dates, the process proceeds to state 308, and a determination is made as to whether the user has also specified and enabled a filter configured to filter out dates posted by users that lack certain characteristics specified by the filter as being needed, or have certain characteristics specified by the filter as being unacceptable. If the user has not specified and enabled the filter, then the process proceeds to state 310, and the search is performed without the filter. If the user has specified and enabled the filter, then the process proceeds to state 312, and the search is performed with the filter. The search engine may, for example, look for and identify posted dates whose associated key words match or partially match those of the search query. The search results are then ordered according to relevancy (closeness of match) or otherwise, and reported to the user. As discussed elsewhere herein, the search results may include detailed information regarding the matching posted dates and regarding the user that posted to the matching date. A control may be provide in conjunction with a given search result enabling the searching user to send an invitation to the user that posted the corresponding date in the search results.

Certain example user interfaces will now be described. The user interfaces may be provided via a website hosted by a dating system, a dedicated phone or computer application, or otherwise.

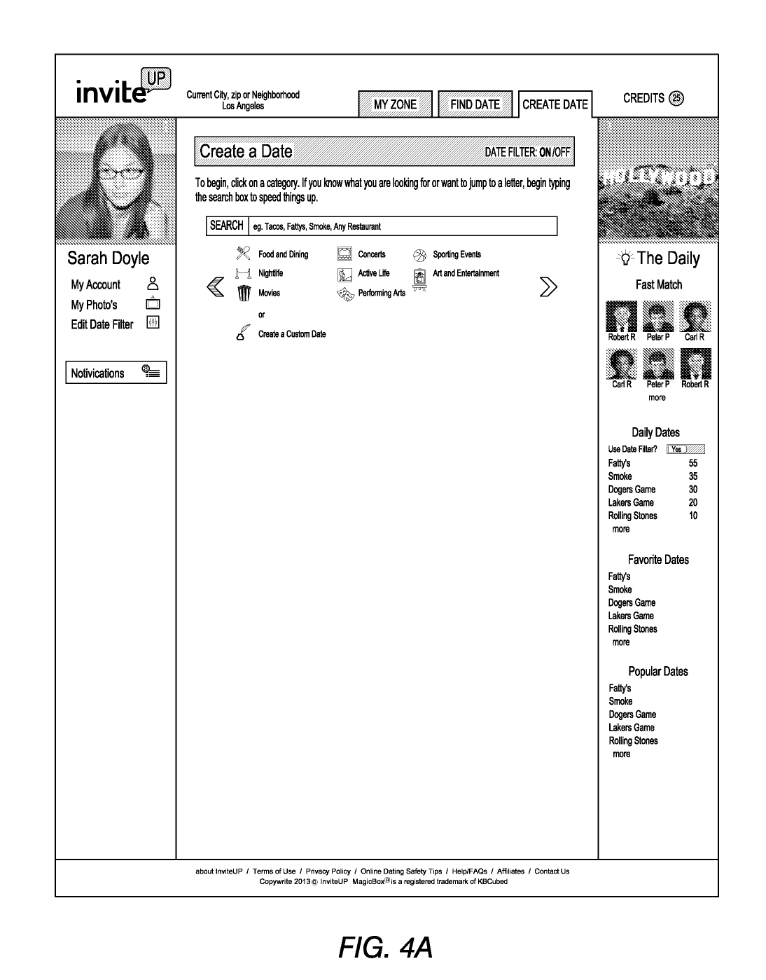

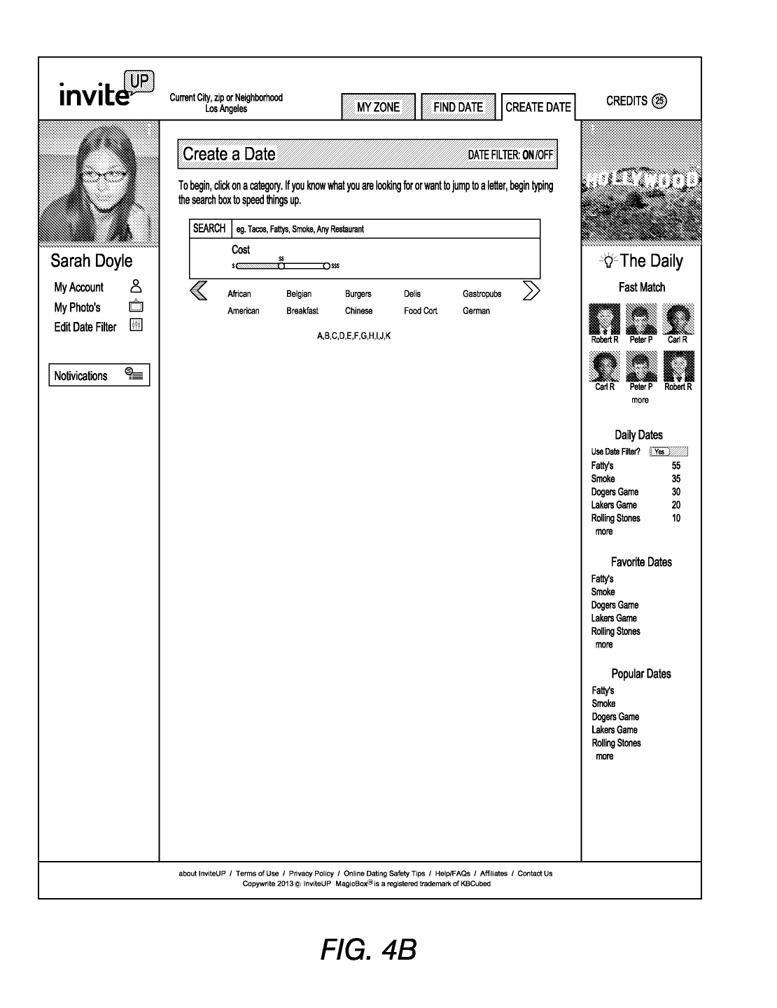

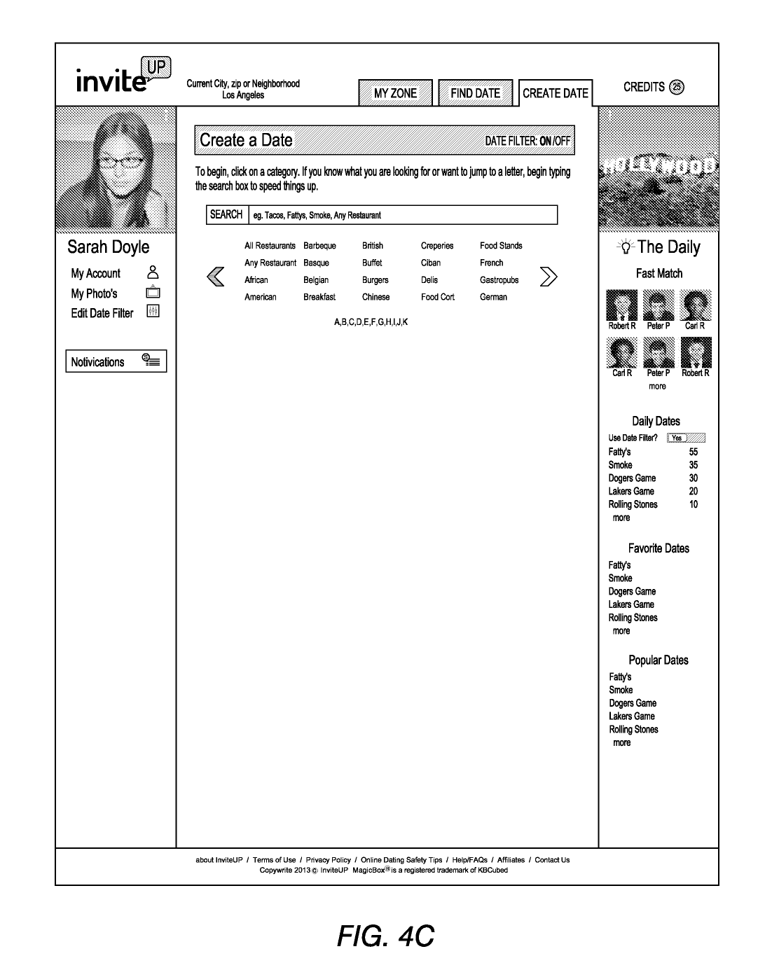

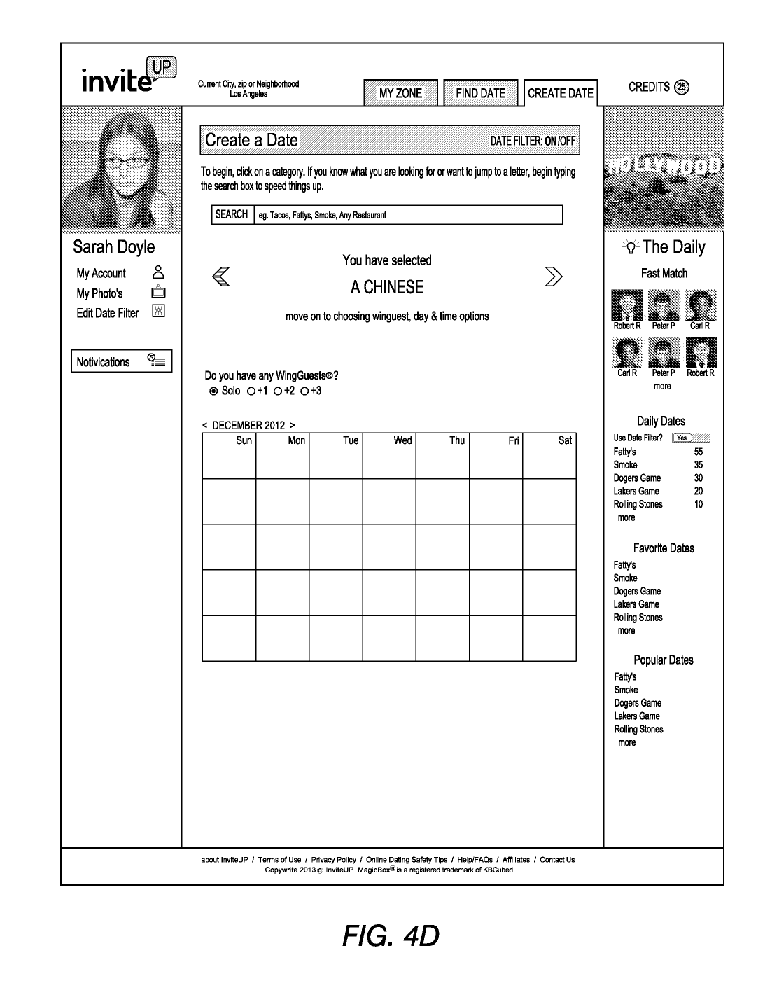

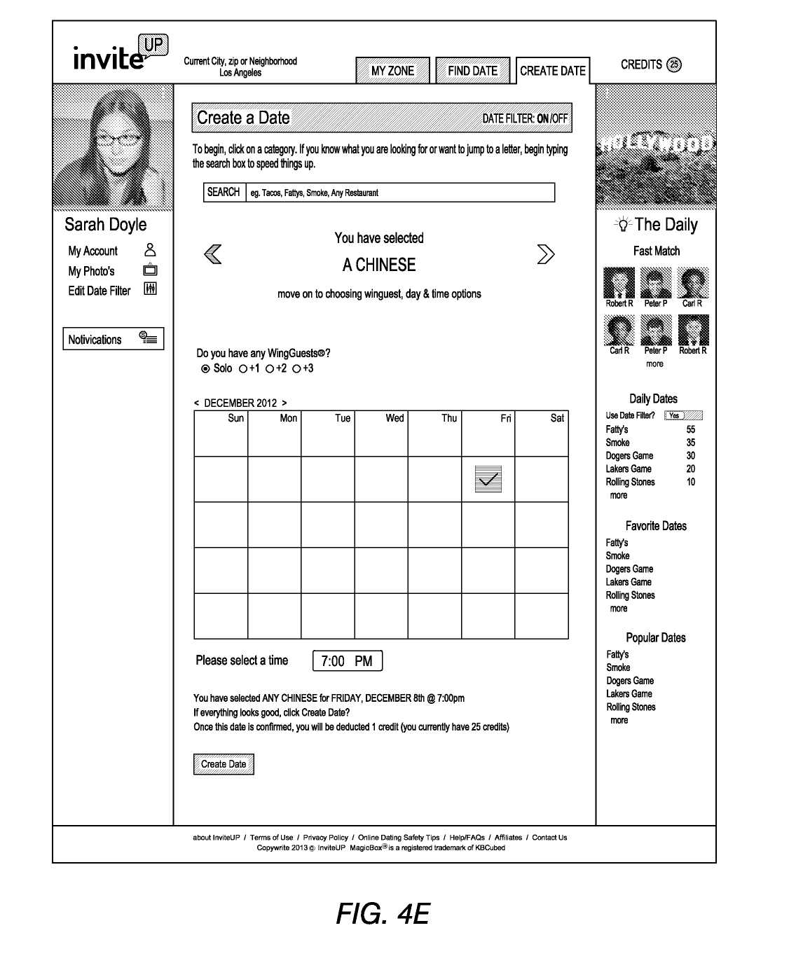

FIG. 4A illustrates an example user interface that a user may utilize to specify a date for a date posting. A system (e.g., a dating system) may determine the user's current and/or registered location (e.g., the city or zip code that is the user's home/work address as indicated by the user in the user's account record and/or the user's current location). The user interface may display such user location information to the user. For example, optionally the system will automatically determine the user's current location (e.g., the city the user is accessing the dating website from) using the user's login IP address. The system may, for example, display the name of the city where the computer, utilized the user to access the dating system, is located. Optionally, the user can change the user location by selecting another city via a menu of cities or by typing in the name (or a portion thereof) of the user's city into a city search field.

Still referring to FIG. 4A, a menu of date categories is provided from which the user can select. For example, the menu of date categories may optionally include food and dining, nightlife, movies, concerts, active life, performing arts, sporting events, etc. The user may scroll through the menu to view additional date categories. In addition, the user may search for a date category by entering a textual search query into a date category search field, and the system will locate and identify to the user matching date categories (if any). Optionally, if the user does not see a predefined satisfactory date category, the user can activate a “create a custom date” control provided via the user interface, which when activated presents a user interface via which the user can specify a custom date that does not fit into one of the predefined categories. For example, a user may be look for someone to go with her to a wedding she is attending, and may specify that the date event is a wedding, taking place at a specified hall, at a specified time, and the dress code for the wedding (e.g., formal, cocktail-style, casual, etc.).

In addition, the illustrated user interface includes account setting information and profile information of the user. The setting and profile information may be accessed by the system from a user account record and provided for display to the user. For example, a photograph of the user and the user's name may be presented. An account control is provided which when activated enables the user to view and edit the user's account information (e.g., contact information, user characteristics, payment information (e.g., credit card number), etc.). A control may be provided which when activated causes the user's photographs and/or photograph albums to be presented. The system may enable the user to upload photographs, delete photographs, edit photographs, and/or organize photographs into one or more albums. A filter control may be provided which enables the user to edit or modify the user's date filter (which may be used to specify desired characteristics in a potential date and/or in date specifications). A control may be provided via which the user can instruct the system to turn on or turn off the date filter. A notification control may be provided which, when activated by the user, causes system and/or other user notifications to be presented.

In addition, fast matches, daily dates, favorite dates, and/or popular dates user interfaces may be provided, as described in greater detail herein. Various of the foregoing features may be provided via some or all of the user interfaces described elsewhere herein.

In this example, once the user selects a date category, a further filter may be provided. For example, if the user selects the food and dining category, a filter interface may be provided, such as that illustrated in FIG. 4B. Optionally, the filter may include a cost filter (e.g., controlled via a cost slider control), via which the user can specify a relative restaurant cost that the user desires. For example, the user may indicate on a scale of 1-10, 1-100, or other scale on how pricey the restaurant should be (e.g., where 1 is very inexpensive and 100 is very expensive). By way of further example, an interface may be provided where the user can enter a typical cost of a meal/per person.

A menu of restaurant categories that satisfy the filter condition(s) may be presented, an example of which is illustrated in FIG. 4C. For example, the restaurant categories may include all restaurants, African, American, Breakfast, Burgers, Chinese, etc. The user may then select a given restaurant category, such as Chinese. A calendar interface may then be presented, such as the example illustrated in FIG. 4D, via which the user can specify one or more calendar days for the date. The displayed calendar may be for the current week, month, or other time period. A forward control and reverse control may be provided enabling the user to navigate to the calendar for the next month or other time period. In addition, the user can specify that one or more of the user's friends will (or will not) be accompanying the user on the date (e.g., as “wingmen”). For example, the user may indicate that 0, 1, 2, 3, or other number of friends will be accompanying the user on the date. A user interface, such as that illustrated in FIG. 4E, may be presented via which the user may specify one or more times for the date. In addition, the date specification as selected by the user may be presented (e.g., Any Chinese for Friday, December 8^{th}, and 7:00 PM). The user may be asked to verify that the presented date specification is correct by activating a corresponding control (e.g., a “create a date” control). The date may then be posted for matching, searching, and/or browsing purposes. Optionally, the user is not charged for the date creation until the user accepts an invitation for the date or the date is otherwise confirmed.

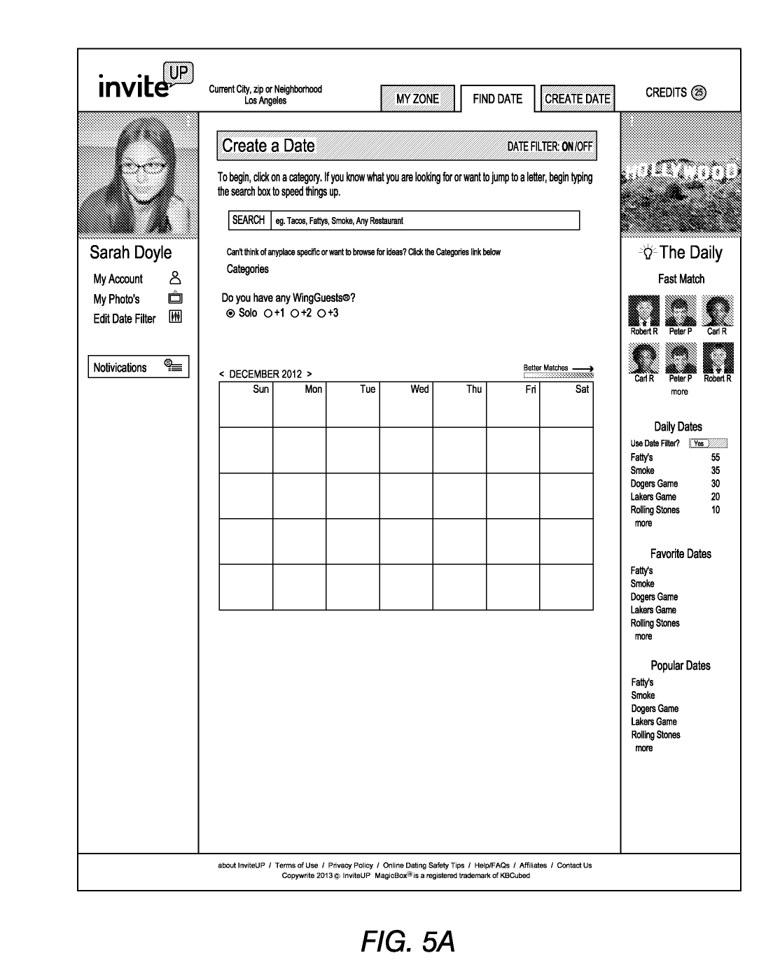

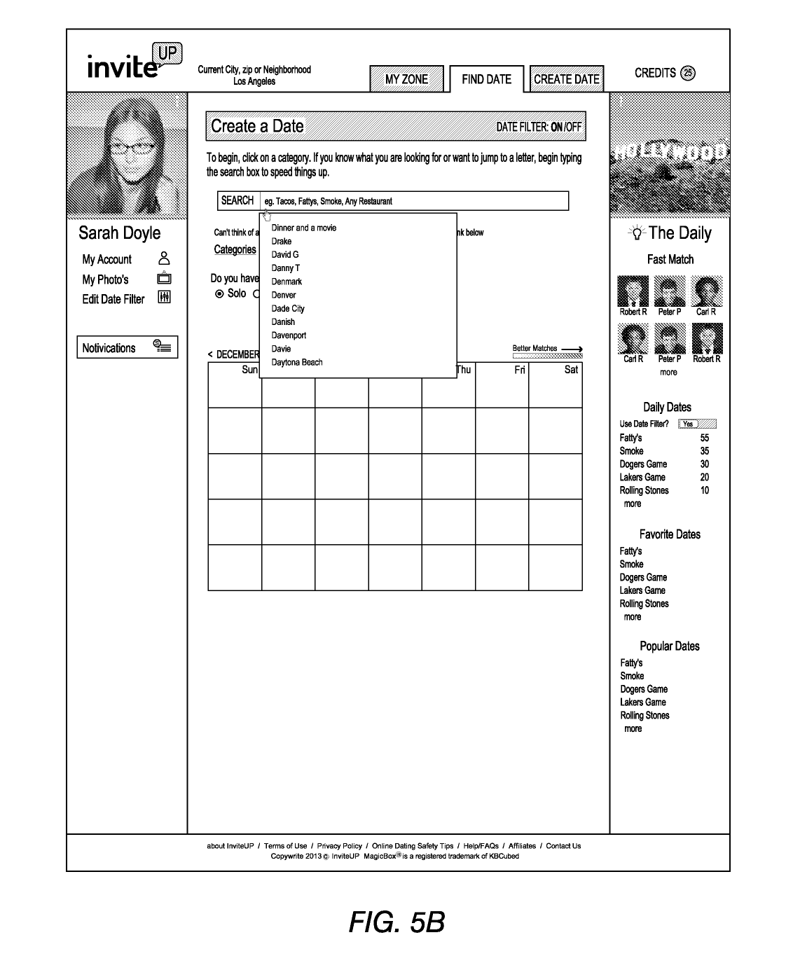

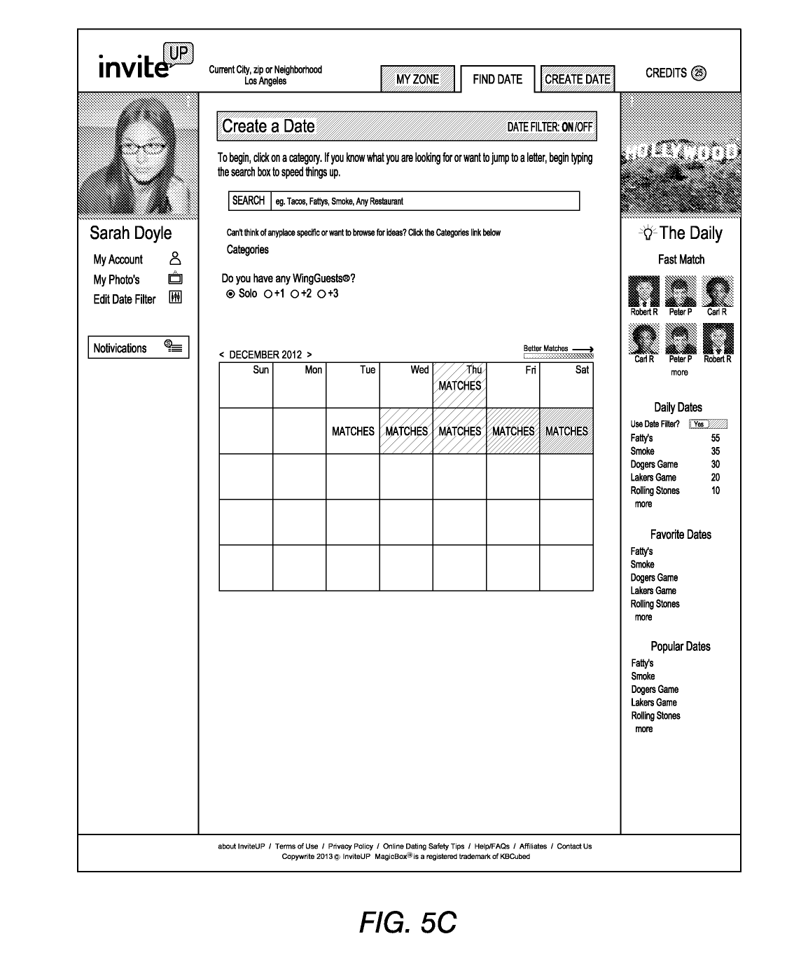

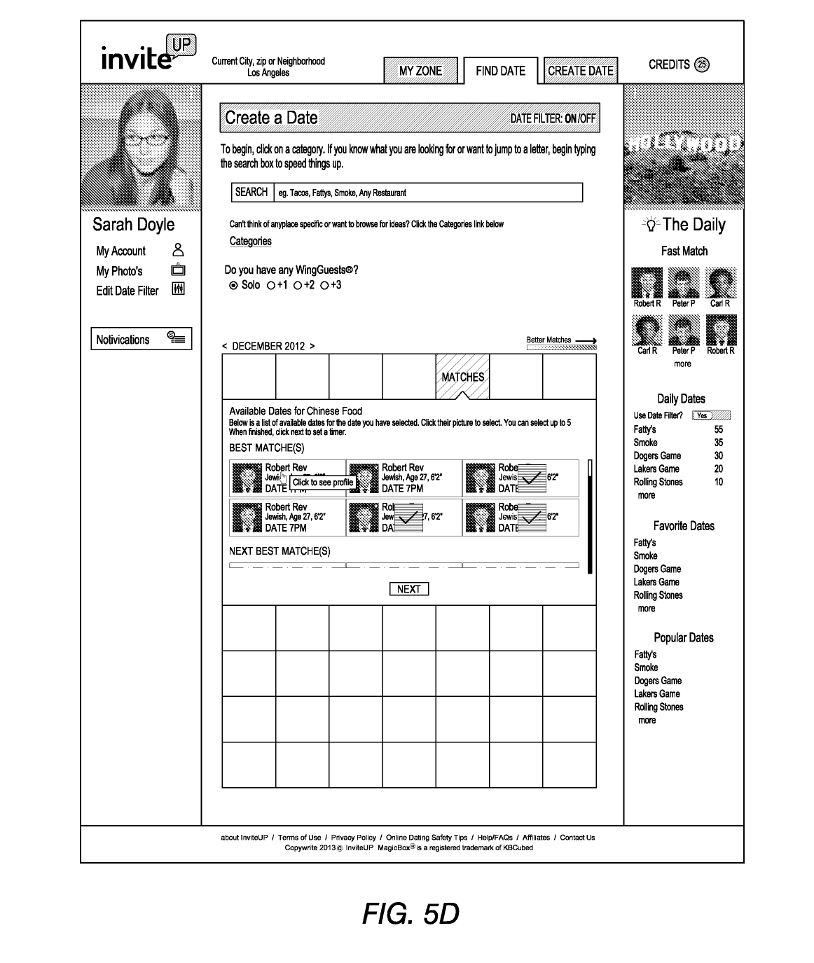

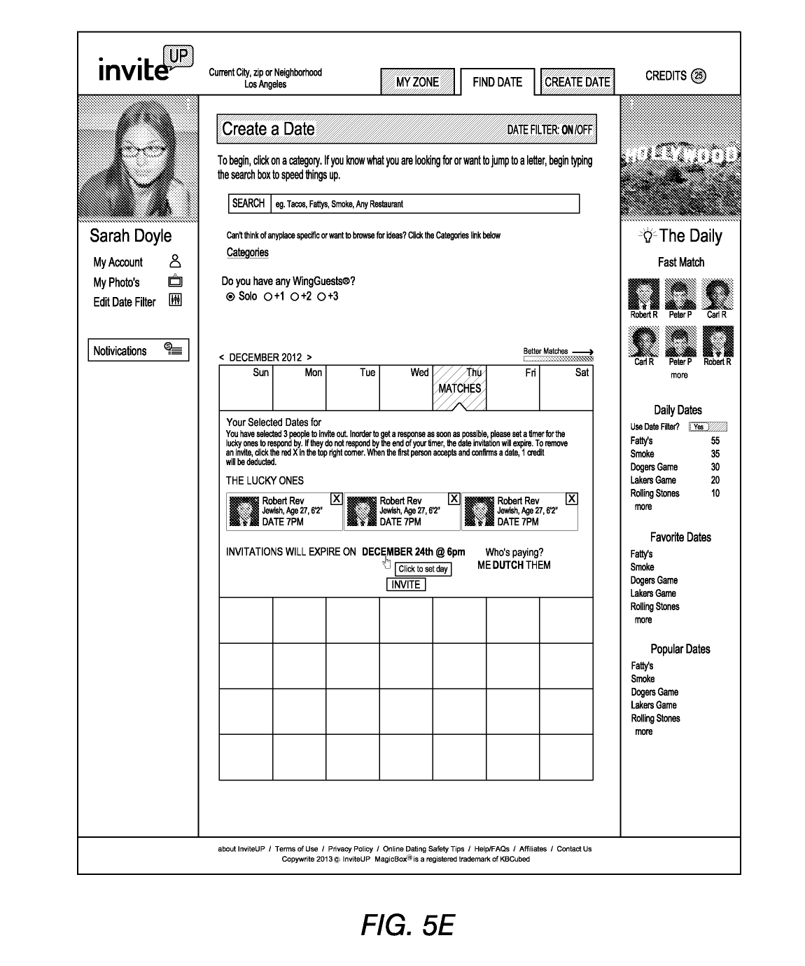

In addition, as discussed elsewhere herein, a user may search for a suitable posted date. For example, with reference to FIG. 5A, a search field may be provided via which the user may enter search query terms (e.g., the name of a date venue, such as a restaurant; a date category, such as dinning or movie; a geographical area, city, etc.). If the user begins to enter text into the search field, optionally the user is presented with suggested search terms that correspond to the search query as it is being entered, as illustrated in FIG. 5B. A menu of date categories may be presented that the user may browse. For example, the user may select movies and browse through posted dates for movies. A calendar may display available dates (or an indication of the existence thereof) on respective calendar days that correspond to the search query. The displayed dates may be displayed with an indication as to relative match closeness of the date to the query. For example, color coding and/or text (e.g., match) may be used to indicate the existence and/or relative match closeness of the date to the query, as illustrated in FIG. 5C.

If the user selects a day on the calendar that has one or more matching dates (e.g., by mousing over, pointing at, or clicking on the day), the matching dates (e.g., including a photo, a name/userID, age, physical characteristics, etc. of the posting user, the date time, etc.) on the selected day may be presented. The presented dates may be organized according to the degree of match (e.g., best matches, next best matches, etc.). The user can select one or more of the presented dates, as illustrated in FIG. 5D. A user interface, such as the example illustrated in FIG. 5E may then be presented. The user interface may present postings for the selected dates optionally without presenting the non-selected dates. The presented postings may present information regarding the posting users, such as name/userID, religion, ethnicity, age, height, etc., particulars regarding the date details for the selected dates (e.g., begin time and/or end time, who is paying, etc.). A control (e.g., an invite control), may be provided via which the user can indicate that the user is interested on going on one of the matching dates for the selected day. The interest will then be communicated to the respective posting user, and if the posting user indicates a reciprocal interest (e.g., by activating an “accept” invitation control), the parties may communicate to coordinate the date as similarly described elsewhere herein. For example, an invitation may be sent to the posting user via a webpage, an email, an SMS message, an MMS message, a push notification, and/or otherwise.

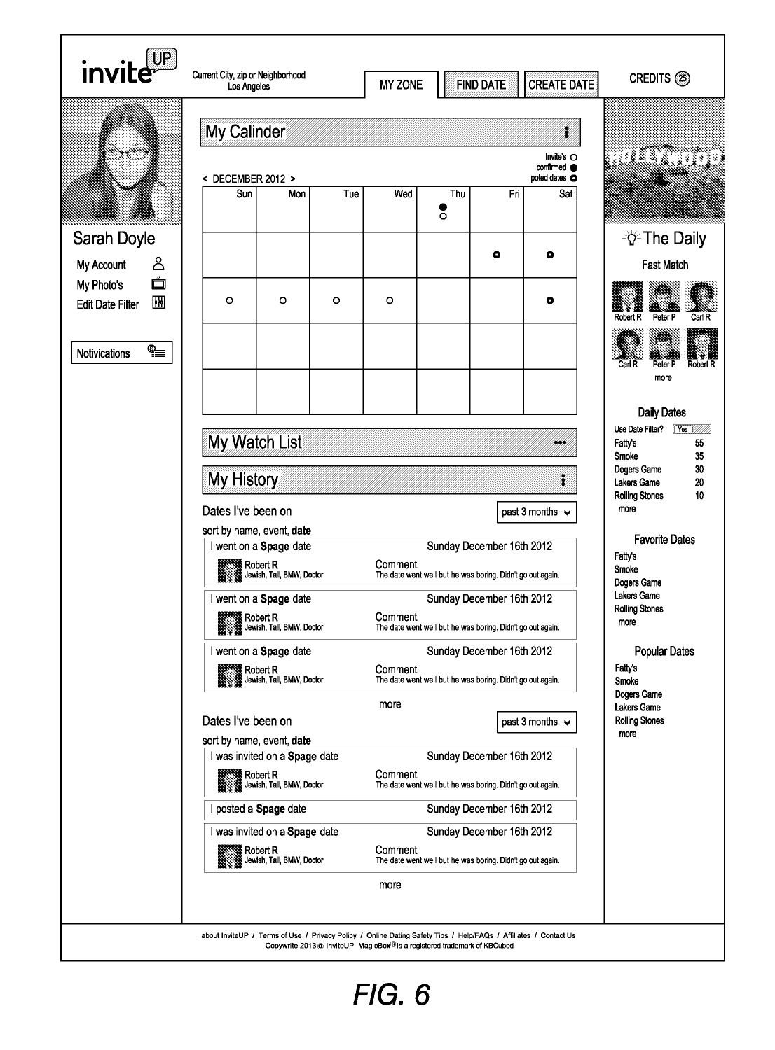

FIG. 6 illustrates a user interface that provides a user with the user's calendar, watch list, dating history, past posts and date invitations using information accessed from a data store. The calendar may list on a day basis which days have a posted date, a confirmed date, or an invite for a date. The dating history may list the dates the user has previously arranged via the dating system. A filter interface may be provided enabling the user to specify a filter to be applied to the dates. For example, the dating history may optionally list all dates, dates over a user or system specified time period (e.g., the last month, the last 3 months, etc.), dates within a certain city or state, etc. A given listing may indicate the date activity, location/venue, date, time, the name or userID, photograph, and/or personal details (e.g., religion, ethnicity, profession, physical characteristics, etc.) of the person the user went on the date with, and a comment entered by the user regarding the date. The date history may be organized by name, event, or date. The past posts and invitations interface may list dates posted by the user and dates on which the user was invited by another user. A given past post and invitation listing may indicate the date activity, location/venue, date, time, the name or userID, photograph, and/or personal details (e.g., religion, ethnicity, profession, physical characteristics, etc.) of the person the user went on the date with, and a comment entered by the user regarding the date, if one occurred, or regarding the other date participant.

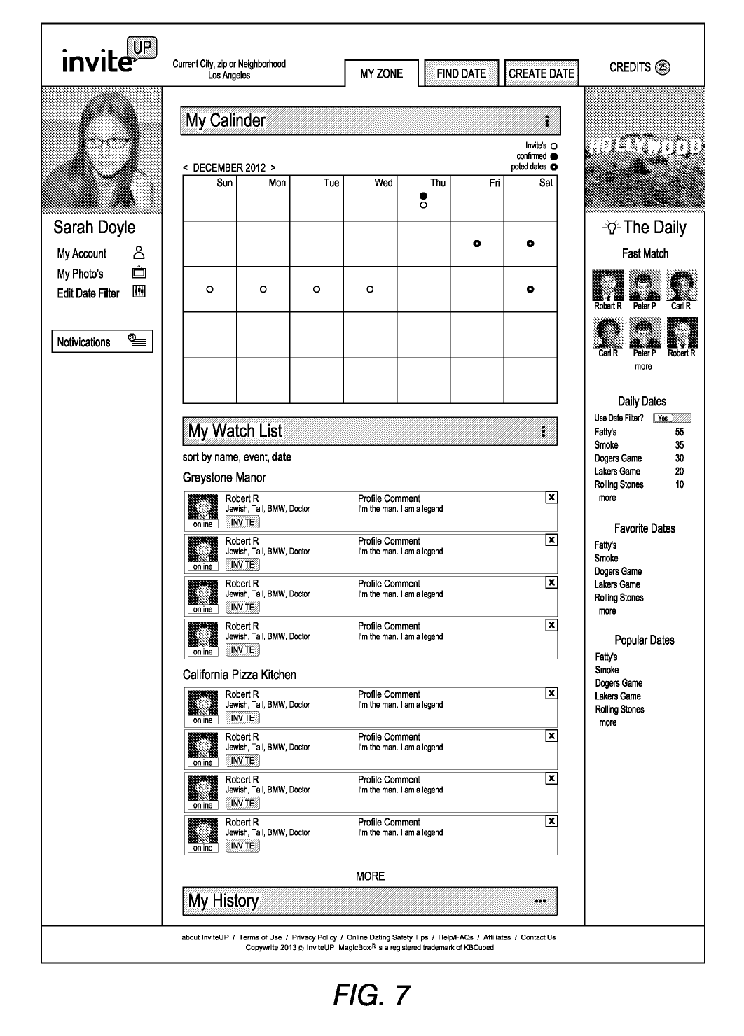

FIG. 7 illustrates an example user interface that provides a user with the user's calendar and a watch list. A watch list may be defined by a user, where the user specifies people, venues and/or activities the user is interested in, but may not have decided to issue an invitation to or for. The system identifies dates posted by the users on the watch list and those of other users that have posted dates for the corresponding specified venues and/or activities on the watch list, and lists those posted dates, organized by the venues/activities of the user's watch list. A given listed posted date may provide profile information regarding the posting user (e.g., a photograph, name/userID, personal characteristics, a profile comment, etc.). The user can indicate an interest in a posted date by activating a control (e.g., an invite control) which may then be processed by the system as similarly discussed elsewhere herein. The user may activate a delete control to cause the system to delete a posted date from the watch list that is not of interest to the user. For example, there may be hundreds of individuals that have expressed an interest to go to an Adele concert (e.g., by posting a date for an Adele concert). As the user looks through the list, the user may identify 10 individuals the user may potentially want to invite to the Adele concert, and the user instructs the system to place the 10 individuals, optionally one-by-one, on the user's watch for further consideration. After the user has completed the review of date postings for the concert, the user can then access and view the user's watch list to more closely examine or review the personal characteristics of each of 10 individuals on the watch list. The user can then invite one or more of the individuals to go on the date to the concert.

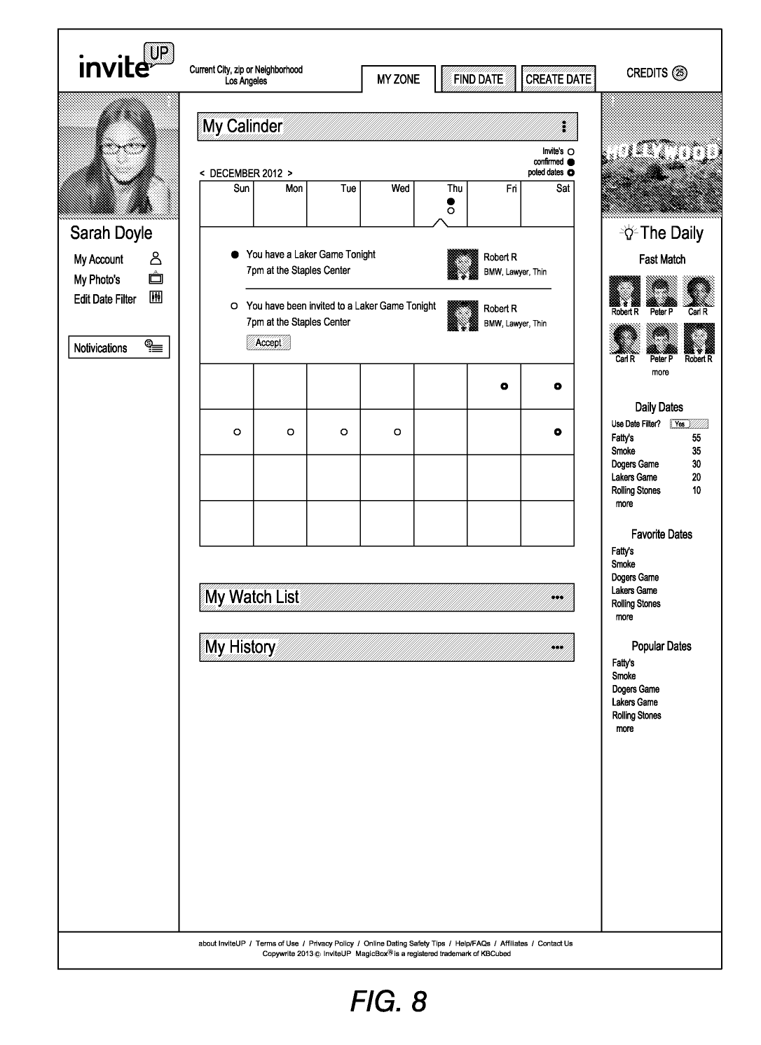

FIG. 8 illustrates another example user interface displaying a user calendar. The calendar displays for a given day (for a daytime period and a nighttime period), via icons and color coding, whether a user has: received an outstanding invite for a posted date for the given day, a confirmed date for the given day, and/or a posted date for the given day. If the user hovers over a given day with a pointer, or otherwise selects a given day, a pop-up window or other interface displays the invitation (e.g., including the event name, venue, time, information on the inviter, etc.), the confirmed date (e.g., including the event name, venue, time, information on the inviter, etc.), and/or the posted date for that day. Optionally, the displayed invitation may include an accept control via which the user may accept the date invitation.

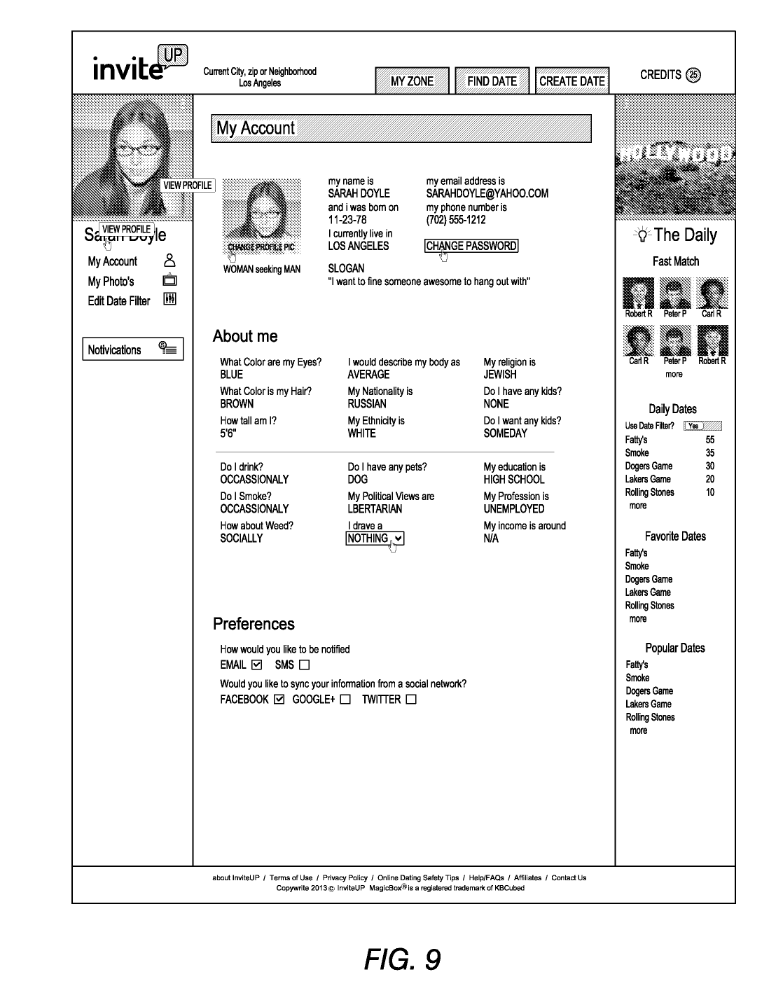

FIG. 9 illustrates an example user account interface via which a user can view and enter/edit account information. For example, the account information may include the user's user name, date of birth, contact information (e.g., email address, phone number, instant messaging identifier, etc.), and a textual description describing the user or the user's goals. The user can also provide descriptive information regarding the user, such as, eye color, hair color, height, weight, body type, nationality, ethnicity, religion, marital status, how many children the user has, whether the user wants children, whether the user drinks, smokes, or uses drugs, whether the user has pets, the user's political views, what type of vehicle the user drives, the user's level of education, the user's profession, the user's income, the user's communication preferences, etc. The profile may include a preference section regarding notification preferences and social network preferences. For example, the user may specify that notifications (e.g., regarding date invitations, date acceptances, etc.) are to be provided via email, SMS, instant messaging, and/or otherwise. The user may also specify which social network accounts of the user should be synchronized with the user's dating system account.

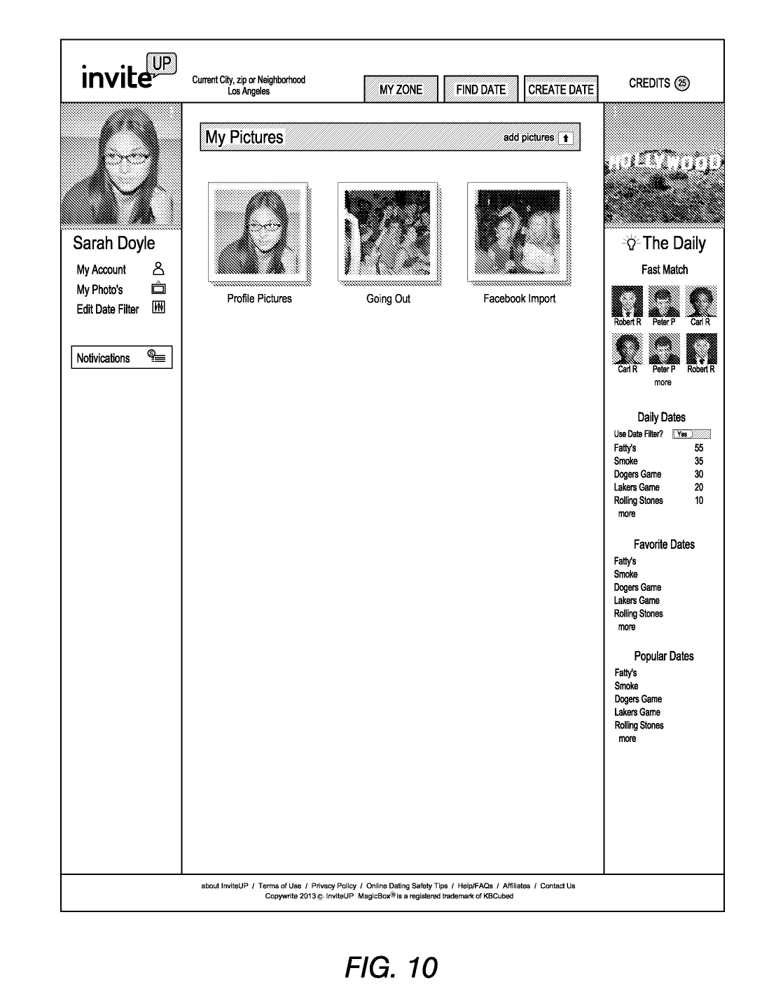

FIG. 10 illustrates an example user interface via which the user can organize their photographs. For example, the user may organize photographs into one or more files/groupings (e.g., profile pictures, date pictures, social network imports, etc.).

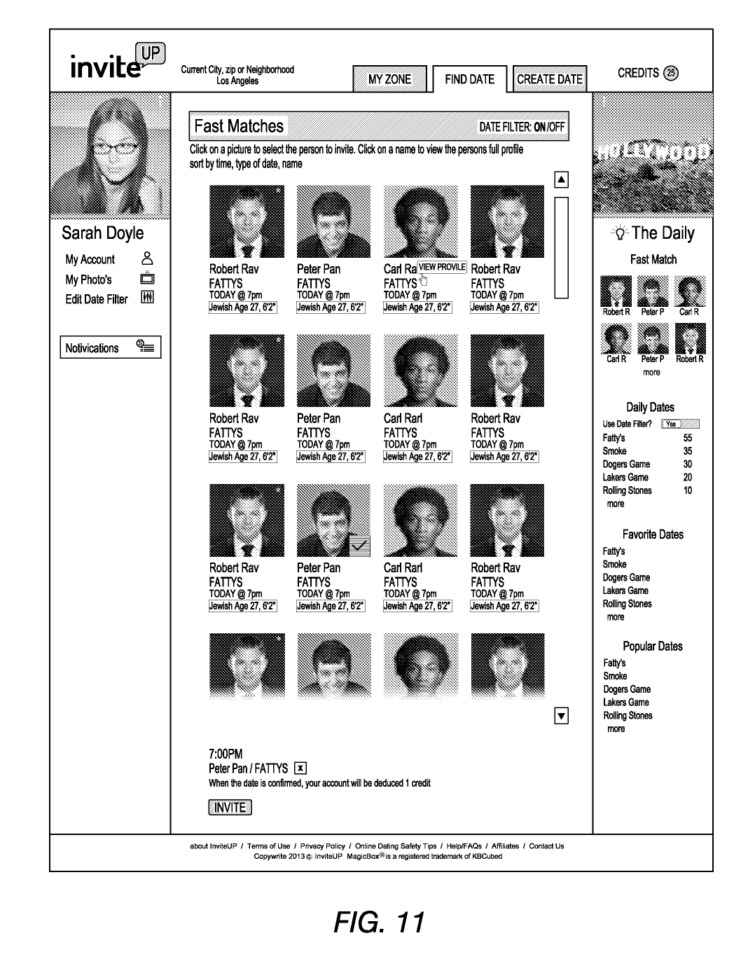

FIG. 11 illustrates an example fast matches user interface. The fast matches interface provides system identified matches for one or more dates that the user has posted. For example if the user has posted a date for the Acme Leaf tea shop on Santa Monica and Doheny for Wednesday night, the system identifies and presents individuals that have posted identical dates (at the same location and time) and/or similar dates (e.g., with a slightly different time, such as no greater than a 30 minutes difference in start time or other threshold, where the threshold may be user and/or system specified). The presentation of individuals may include photographs and/or other profile information regarding the respective individuals, and may optionally provide details on their respective date postings. Optionally, the fast matches interface may display posted dates as having a category that matches that of the date posted by the user. For example, the category may be Coffee in Santa Monica on Wednesday night. The system identifies and displays individuals that have posted dates with the Coffee category at locations in Santa Monica on Wednesday night, regardless of the particular chain/store (e.g., the system may identify and display individuals that have posted dates at the Acme coffee shop, the Beta coffee shop, and the Zeta coffee shop, in Santa Monica on Wednesday night).

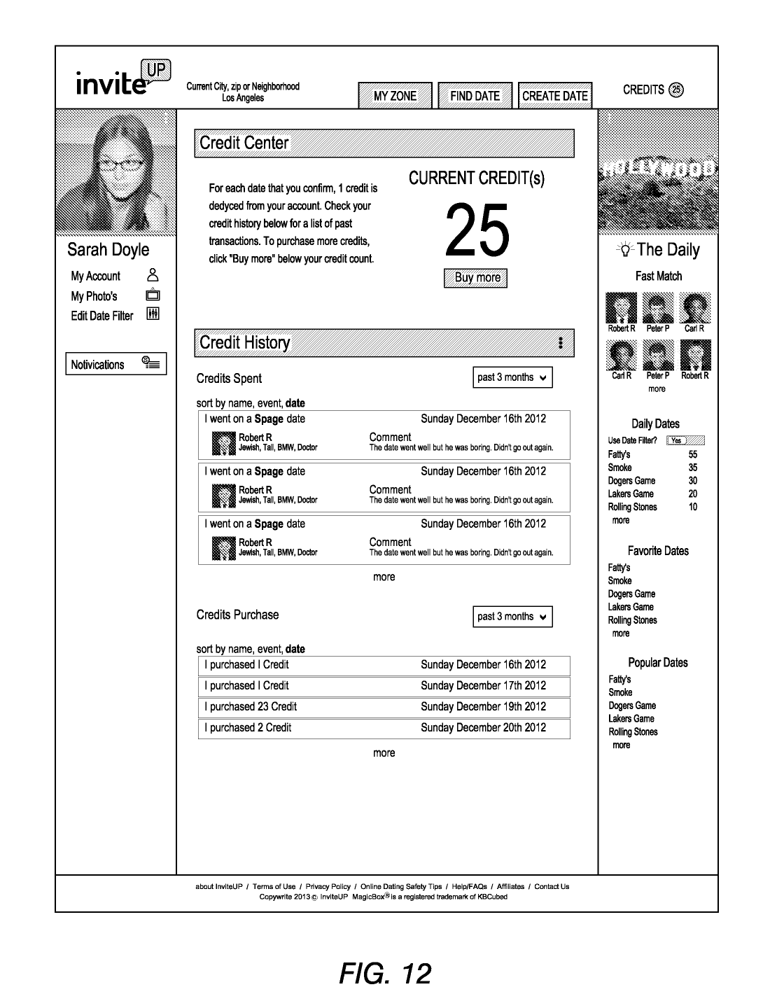

FIG. 12 illustrates an example credit center user interface. Optionally a user may purchase one or more credits which may be associated with the user's account. The credits may be used to pay for dates as described elsewhere herein. The user interface may display how many credits the user has. In addition, the account user interface may provide a credit history, listing the dates the user has gone on and spent credits for, as well as the user's comments/rating of the date. The history may also indicate when the user purchased credits, and how many credits were purchased at a given time. The history may be limited to a specified time selected by the user or system (e.g., the last 3 months, the last 6 months, or other time period).

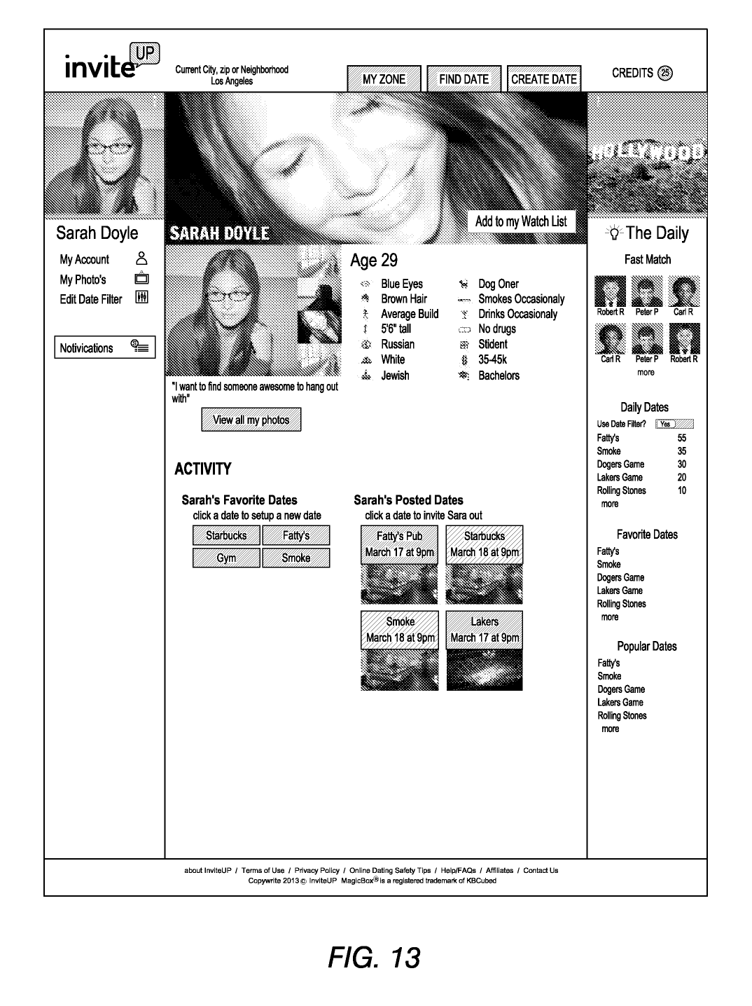

FIG. 13 illustrates an example user's profile page, which may be viewed by the user's whose profile it is, and/or other users. The profile page may include one or more photographs of the user and characteristics of the user (e.g., age, color of eyes, hair color, build, height, nationality, race, religion, hobbies, likes animals, smoking habits, drinking habits, drug use, profession, income, education, marital status, sexual preferences, etc.). The profile page may also list the user's favorite dates (e.g., favorite date venues and/or activities) and the user's posted dates (e.g., venue, activity, date, time). The posted dates may have an associated invite control which when activated causes an invitation be sent to the user for the posted date, identifying who is sending the invitation as similarly discussed elsewhere herein.

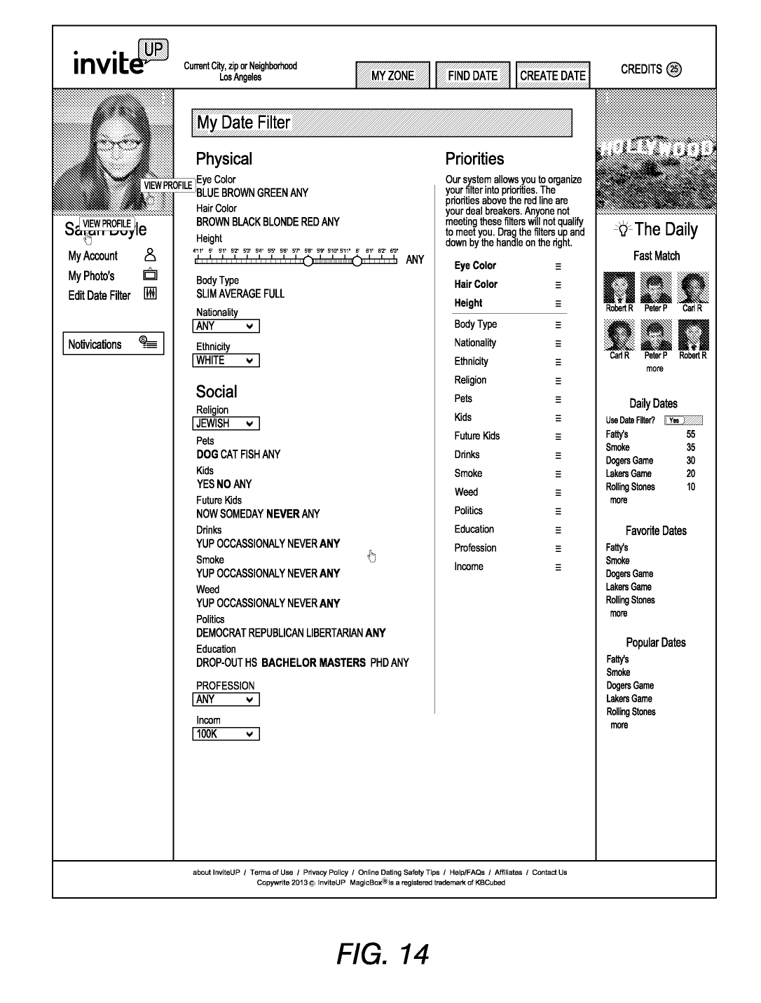

FIG. 14 illustrates an example date filter user interface via which the user can specify various desired features in a potential date, such as height, body type, eye color, hair color, nationality, ethnicity, religion, pets, current children status, intent regarding potential future children, alcohol drinking habits, smoking habits, drug use habits, political affiliations/leanings, education level, profession, income, etc. In addition, an interface may be provided via which the user can specify priorities with respect to the various filter criteria. Optionally, the interface enables the user to specify that certain criteria are “must haves”, where anyone not satisfying the “must have” criteria will not be presented to the user when the user enables the filter and the filter is applied.

Thus, as described herein, certain embodiments provide a fast and efficient way for people to meet and arrange dates. Certain embodiments process date trend information to identify to users popular dates. Certain embodiments facilitate the identification and provision of advertisements relevant to a given posted date. Certain embodiments enable date posting information to be populated via an API from a date venue or event.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The results of the disclosed methods may be stored in any type of computer data repository, such as relational databases and flat file systems that use volatile and/or non-volatile memory (e.g., magnetic disk storage, optical storage, EEPROM and/or solid state RAM).

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone application, computer application, a short messaging service message (e.g., SMS, MMS, etc.), instant messaging, email, push notification, audibly, and/or otherwise. Optionally, user interfaces may be provided with editing tools, enabling users to select, cut, copy, paste, undo, redo, and otherwise edit user provided content and/or other content.

The user terminals described herein may be in the form of a mobile communication device (e.g., a cell phone), laptop, tablet computer, interactive television, game console, media streaming device, head-wearable display, networked watch, etc.

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the invention can be practiced in many ways. As is also stated above, the use of particular terminology when describing certain features or aspects of certain embodiments should not be taken to imply that the terminology is being re-defined herein to be restricted to including any specific characteristics of the features or aspects of the invention with which that terminology is associated.

What is claimed is:

1. A system configured to facilitate relationships, the system comprising:
at least one processing device;
a posting module stored in non-transitory memory and executable by the at least one processing device, the posting module configured to enable a user to specify via a first interface information for a date posting, including at least a date venue, calendar day, and time to be included in the date posting;
a first application programming interface configured to:
access at least a portion of the information specified by a first user for a first date posting, including at least a first date venue specified by the first user,
access a database associated with the first date venue specified by the first user, or access a database associated with a third party service provider storing information related to the first date venue, or access the database associated with the first date venue specified by the first user and the database associated with a third party service provider storing information related to the first date venue;
receive information related to the first date venue from the database associated with the first date venue, or the database associated with a third party service provider, or the database associated with the first date venue specified by the first user and the database associated with a third party service provider storing information related to the first date venue;
a date posting population module, stored in non-transitory memory and executable by the at least one processing device, configured to populate the first date posting with at least a portion of the information specified by the first user and at least a portion of the information received via:
the application programming interface from the database associated with the first date venue, or
the database associated with a third party service provider, or
the application programming interface from the database associated with the first date venue and the database associated with a third party service provider;
a search engine configured to identify the first date posting at least partly in response to an action of a second user, and to provide the first date posting, including at least a portion of the information received via the application programming interface, for display to the second user;
a module, stored in non-transitory memory and executable by the at least one processing device, configured to:
cause an invitation control to be displayed to the second user in association with the first date posting;
detect whether the second user activated the invitation control;
at least partly in response to detecting that the second user activated the invitation control, cause an invitation, to go on a date corresponding to the first date posting of the first user, to be presented to the first user;
detect whether the first user accepted the invitation;
at least partly in response to detecting that the first user accepted the invitation:
notify the second user regarding the acceptance, and
charge the first user or the second user, or both the first user and the second user.

2. The system as defined in claim 1, wherein the system comprises a second application programing interface configured to enable a venue system associated with at least one venue to provide users of a networked site associated with the venue system associated with at least one venue to post dates to occur at the at least one venue and to issue invitations using the system.

3. The system as defined in claim 1, wherein the system is configured to enable the first user to access a date posting of at least one other user, edit the date posting of the at least one other user, and save the edited date posting as a date posting of the first user.

4. The system as defined in claim 1, wherein the system is configured to automatically identify date postings for dates specified to take place on a current day within a specified geographical area, and cause at least a portion of the identified dates specified to take place on the current day within the specified geographical area to be presented to the first user.

5. The system as defined in claim 1, wherein the system is configured to enable a given user to specify:
(i) favorite date venues, or
(ii) favorite activities, or
(iii) both (i) and (ii),
without specifying associated calendar days; and
based at least in part on (i), (ii) or (iii), identify posted dates from other users that correspond to (i), (ii) or (iii).

6. The system as defined in claim 1, wherein the system is configured to enable a given user to specify a watch list including other users, and based at least in part on the watch list, identify date postings posted by users on the watch list in substantially real time.

7. The system as defined in claim 1, wherein the system is configured to track quantities of postings for a plurality of different date activities for a given geographical area in a specified period of time, identify at least a first number of most popular date activities, and present for display to a given user the first number of most popular date activities.

8. The system as defined in claim 1, wherein the first user and the second user are not charged a periodic subscription fee to utilize the dating system for arranging dates.

9. The system as defined in claim 1, wherein the system is configured to enable the first user to specify an expiration timing for the first date posting and enable the second user to specify an expiration timing for the invitation.

10. The system as defined in claim 1, wherein the system is configured to:
enable the second user to cause a plurality of invitations for dates to be transmitted to respective different users for dates to occur at substantially the same time;
detect an acceptance of a first of the plurality of invitations; and
at least partly in response to detecting the acceptance of the first of the plurality of invitations, cause other of the plurality of invitations to lapse.

11. The system as defined in claim 1, wherein the system is configured to:
identify a plurality of date postings posted by the first user for at least a first time period;
determine calendar days specified by the first user for the respective plurality of date postings;
determine for which of the plurality of date postings invitations from other users have been issued to the first user;
if there are issued invitations, determine which of the issued invitations have been accepted by the first user;
provide a calendar for display to the first user, the calendar indicating for each of the plurality of date postings posted by the first user for the first time period, a respective determined calendar day, an indication as to whether an invitation has been issued, and if the invitation has been issued, an indication as to whether the first user has accepted the invitation.

12. The system as defined in claim 1, wherein the received information related to the first date venue from: the database associated with the first date venue, or the database associated with the third party service provider, or the database associated with the first date venue and the third party service provider comprises:
(a) an address; or
(b) a phone number; or
(c) a schedule of operating time; or
(d) any combination of (a), (b), (c).

13. The system as defined in claim 1, wherein the received information related to the first date venue from: the database associated with the first date venue, or the database associated with the third party service provider, or the database associated with the first date venue and the third party service provider comprises:
(a) food type; or
(b) cost; or
(c) reviews; or
(d) music; or
(e) ambiance; or
(f) any combination of (a), (b), (c), (e).

14. The system as defined in claim 1, wherein the application programming interface is further configured to transmit a reservation request to:
the first date venue, or
a service provider that accepts reservations on behalf of the first date venue, or
both the first date venue and the service provider that accepts reservations on behalf of the first date venue.

15. The system as defined in claim 1, wherein the application programming interface is further configured to transmit a ticket purchase request to:
the first date venue, or
a service provider that accepts reservations on behalf of the first date venue, or
both the first date venue and the service provider that accepts reservations on behalf of the first date venue.

16. The system as defined in claim 1, wherein the posting module is further configured to enable the user to specify if the user will pay a fee charged by the system on behalf of another user that issues an invitation to the user.

17. The system as defined in claim 1, wherein the posting module is further configured to enable the user to specify if the user wants an inviting user issuing a date invitation to the user to pay a fee on behalf of the user charged by the system.

18. The system as defined in claim 1, wherein the system is configured to:
maintain a record of dates, arranged via the system, the first user has gone on during at least a first period of time;
maintain a record of user textual comments regarding the dates arranged via the system, or user ratings regarding the dates arranged via the system, or both user textual comments regarding the dates via the system and user ratings regarding the dates arranged via the system;
generate and provide to the user a report based at least in part in the record of dates and the record of user textual comments regarding the dates arranged via the system, or user ratings regarding the dates arranged via the system, or both user textual comments regarding the dates via the system and user ratings regarding the dates arranged via the system.

19. The system as defined in claim 1, wherein the system is configured to display, in a single document, potential matches for a plurality of dates posted by the user.

20. The system as defined in claim 1, wherein the system is configured to display, on a home page of the user, potential matches for a plurality of dates posted by the user.

21. A method, comprising:
receiving at a computer system from a terminal associated with a first user a date posting, including at least a date venue, a calendar day, and a time to be included in the date posting;
accessing, by the computer system, at least a portion of the information specified by a first user for a first date posting, including at least a first date venue specified by the first user,
accessing:
a database associated with the first date venue specified by the first user, or
a database associated with a third party service provider storing information related to the first date venue, or
the database associated with the first date venue specified by the first user and the database associated with a third party service provider storing information related to the first date venue;
receiving information related to the first date venue from the database associated with the first date venue, or the database associated with a third party service provider, or the database associated with the first date venue specified by the first user and the database associated with a third party service provider storing information related to the first date venue;
populating, by the computer system, the first date posting with at least a portion of the information specified by the first user and at least a portion of the information received from:
the database associated with the first date venue, or
the database associated with a third party service provider, or
the database associated with the first date venue and the database associated with a third party service provider;
identifying, using a first search engine executing on at least one computer system, the first date posting at least partly in response to an action of a second user;
providing the first date posting, including at least a portion of the information received via the database associated with the first date venue, or the database associated with a third party service provider, or the database associated with the first date venue and the database associated with a third party service provider, for display to the second user;
causing an invitation control to be displayed to the second user in association with the first date posting;
detecting whether the second user activated the invitation control;
at least partly in response to detecting that the second user activated the invitation control, causing an invitation, to go on a date corresponding to the first date posting of the first user, to be presented to the first user;
detecting whether the first user accepted the invitation;
at least partly in response to detecting that the first user accepted the invitation:
notifying the second user regarding the acceptance, and
charging the first user or the second user, or both the first user and the second user.

22. The method as defined in claim 21, the method further comprising enabling a venue system associated with at least one venue to provide users of a networked site associated with the venue system associated with at least one venue to post dates to occur at the at least one venue and to issue invitations.

23. The method as defined in claim 21, the method further comprising enabling the first user to access a date posting of at least one other user, edit the date posting of the at least one other user, and save the edited date posting as a date posting of the first user.

24. The method as defined in claim 21, the method further comprising automatically identifying date postings for dates specified to take place on a current day within a specified geographical area, and cause at least a portion of the identified dates specified to take place on the current day within the specified geographical area to be presented to the first user.

25. The method as defined in claim 21, the method further comprising enabling a given user to specify:
(i) favorite date venues, or
(ii) favorite activities, or
(iii) both (i) and (ii),
without specifying associated calendar days; and
based at least in part on (i), (ii) or (iii), identifying posted dates from other users that correspond to (i), (ii) or (iii).

26. The method as defined in claim 21, the method further comprising enabling a given user to specify a watch list including other users, and based at least in part on the watch list, identifying date postings posted by users on the watch list in substantially real time.

27. The method as defined in claim 21, the method further comprising tracking quantities of postings for a plurality of different date activities for a given geographical area in a specified period of time, identifying at least a first number of most popular date activities, and present for display to a given user the first number of most popular date activities.

28. The method as defined in claim 21, wherein the first user and the second user are not charged a periodic subscription fee to utilize the dating system for arranging dates.

29. The method as defined in claim 21, the method further comprising enabling the first user to specify an expiration timing for the first date posting and enabling the second user to specify an expiration timing for the invitation.

30. The method as defined in claim 21, the method further comprising:
enabling the second user to cause a plurality of invitations for dates to be transmitted to respective different users for dates to occur at substantially the same time;
detecting an acceptance of a first of the plurality of invitations; and
at least partly in response to detecting the acceptance of the first of the plurality of invitations, causing other of the plurality of invitations to lapse.

31. The method as defined in claim 21, the method further comprising:
identifying a plurality of date postings posted by the first user for at least a first time period;
determining calendar days specified by the first user for the respective plurality of date postings;
determining for which of the plurality of date postings invitations from other users have been issued to the first user;
if there are issued invitations, determining which of the issued invitations have been accepted by the first user;
providing a calendar for display to the first user, the calendar indicating for each of the plurality of date postings posted by the first user for the first time period, a respective determined calendar day, an indication as to whether an invitation has been issued, and if the invitation has been issued, an indication as to whether the first user has accepted the invitation.

32. The method as defined in claim 21, wherein the received information related to the first date venue from: the database associated with the first date venue, or the database associated with the third party service provider, or the database associated with the first date venue and the third party service provider comprises:
(a) an address; or
(b) a phone number; or
(c) a schedule of operating time; or
(d) any combination of (a), (b), (c).

33. The method as defined in claim 21, wherein the received information related to the first date venue from: the database associated with the first date venue, or the database associated with the third party service provider, or the database associated with the first date venue and the third party service provider comprises:
(a) food type; or
(b) cost; or
(c) reviews; or
(d) music; or
(e) ambiance; or
(f) any combination of (a), (b), (c), (e).

34. The method as defined in claim 21, the method further comprising transmitting a reservation request to:
the first date venue, or
a service provider that accepts reservations on behalf of the first date venue, or
both the first date venue and the service provider that accepts reservations on behalf of the first date venue.

35. The method as defined in claim 21, the method further comprising transmitting a ticket purchase request to:
the first date venue, or
a service provider that accepts reservations on behalf of the first date venue, or
both the first date venue and the service provider that accepts reservations on behalf of the first date venue.

36. The method as defined in claim 21, the method further comprising enabling the user to specify if the user will pay a fee charged by the system on behalf of another user that issues an invitation to the user.

37. The method as defined in claim 21, the method further comprising enabling the user to specify if the user wants an inviting user issuing a date invitation to the user to pay a fee on behalf of the user charged by the system.

38. The method as defined in claim 21, the method further comprising:
maintaining a record of dates, arranged via the system, the first user has gone on during at least a first period of time;
maintaining a record of user textual comments regarding the dates arranged via the system, or user ratings regarding the dates arranged via the system, or both user textual comments regarding the dates via the system and user ratings regarding the dates arranged via the system;
generating and provide to the user a report based at least in part in the record of dates and the record of user textual comments regarding the dates arranged via the system, or user ratings regarding the dates arranged via the system, or both user textual comments regarding the dates via the system and user ratings regarding the dates arranged via the system.

39. The method as defined in claim 21, the method further comprising displaying, in a single document, potential matches for a plurality of dates posted by the user.

40. The method as defined in claim 21, the method further comprising displaying, on a home page of the user, potential matches for a plurality of dates posted by the user.
